(19) United States
(12) Patent Application Publication
(10) Pub. No.: US 2013/0311196 A1
(43) Pub. Date: Nov. 21, 2013

(54) Establishing Risk-Based Study Conduct

(71) Applicant: Medtronic, Inc., Minneapolis, MN (US)

(72) Inventors: Margaret F. Fay, Suwanee, GA (US); Kimberly A. Oleson, Shoreview, MN (US)

(73) Assignee: Medtronic, Inc., Minneapolis, MN (US)

(21) Appl. No.: 13/895,518

(22) Filed: May 16, 2013

Related U.S. Application Data
(60) Provisional application No. 61/648,986, filed on May 18, 2012.
(60) Provisional application No. 61/649,257, filed on May 19, 2012.

(51) Int. Cl. G06Q 10/06; G06Q 50/22

(52) U.S. Cl. CPC G06Q 10/0635; G06Q 50/22
USPC 705/2

(57) ABSTRACT

A computer system is configured before a start of a trial of a medical therapy to detect alert conditions. The alert conditions are indicative of occurrences of failure modes identified as being potentially associated with the trial. During the trial, the computer system receives trial data. The computer system detects, based on the trial data, that one or more of the alert conditions have occurred. In response to detecting that an alert condition has occurred, the computer system outputs an alert associated with a mitigation procedure defined for the given failure mode before the start of the trial. The mitigation procedure indicates a procedure to mitigate the occurrence of the given failure mode.

This application claims the benefit of U.S. Provisional Patent Application No. 61/648,988, filed May 18, 2012, and U.S. Provisional Patent Application No. 61/649,257, filed May 19, 2012, then entire content of each of which is incorporated herein by reference.

### BACKGROUND

In general, sponsoring organizations (referred to herein as “sponsors”) develop medical therapies with the intent of bringing the medical therapies to market. For instance, a sponsor may develop a new medical device, a new drug, a new biological compound, a new use for an existing medical device or drug, a new medical treatment process or procedure, or another type of medical therapy. In some instances, a medical therapy may be referred to as an investigational product. A study treatment may be a drug, device, therapy or process under investigation in a clinical trial which has an effect on outcome of interest in a study: e.g. health-related quality of life, efficacy, safety, and pharmacoeconomics. A study treatment may also be referred to as an intervention, a therapeutic intervention, a medical product, or an investigational product.

Before a sponsor can bring a medical therapy to market, the medical therapy must undergo various trials to ensure the safety and efficacy of the medical therapy. For instance, the medical therapy may undergo a clinical trial in which the medical therapy is used on actual persons (also referred to as human subjects). If the trials demonstrate that the medical therapy is safe and effective, the medical therapy may be approved for market.

To conduct a trial on a medical device, a sponsor may first develop a trial protocol. The trial protocol describes how to conduct the trial. For instance, the trial protocol may provide instructions on how to recruit study subjects, how to collect information from the patients, how to administer the medical therapy, what information to collect from the patients, and how to perform other aspects of the trial.

The sponsor may then engage (e.g., hire) one or more research organizations (i.e., investigators) to conduct the trial on the medical therapy. To help ensure that the results of the trial are not biased, the investigators may be organizations that are independent of the sponsor. The sponsor instructs the investigators to conduct the trials in accordance with the trial protocol developed for the medical therapy. The investigators may provide data associated with the trial to the sponsor during the trial and/or upon completion of the trial.

At the end of the trial, the sponsor may submit an application to a regulatory agency, such as the United States Food and Drug Administration (FDA). The application may include the data provided by the investigators. The regulatory agency may then decide, on the basis of the data in the application, whether to allow the sponsor to bring the medical therapy to market.

For various reasons, the trial may encounter problems. For example, the investigators may not always comply with the trial protocol while conducting the trial. In another example, an investigator may fail to obtain proper consent from study subjects. In another example, an investigator may fail to administer the medical therapy correctly. In another example, an investigator may fabricate results.

The sponsor may engage one or more monitoring organizations (i.e., monitors) to periodically visit the investigators to determine whether the investigators are conducting the trial correctly. Monitors may also be referred to as Clinical Research Associates (CRAs) or study monitors. To help ensure that the monitors do not bias the trial, the monitors may be organizations that are independent of both the sponsors and the investigators. In some instances, the monitors may be independent contractors or the monitors may be qualified CRAs by education and training hired by the sponsor. In some instances, a monitor may intervene to correct a problem if the monitor finds that an investigator is not conducting the trial correctly in accordance with an approved protocol or governing regulations. In some instances, a monitor may report non-compliance to the sponsor in addition, or as an alternative, to intervention.

### SUMMARY

This disclosure describes techniques performed by one or more computer systems to facilitate risk-based conduct of trials of medical therapies. In accordance with the techniques, a computer system may receive configuration data before a trial starts. The configuration data may configure the computer system to detect alert conditions indicative of occurrences of risks identified as being potentially associated with the trial. In addition, the computer system may receive trial data generated during conduct of the trial. In some examples, the trial data may be generated by one or more investigators as part of the investigators conducting the trial behalf of a sponsor of the trial. The computer system may detect, based on the trial data, that one of the alert conditions has occurred. In response to detecting that the alert condition has occurred, the computer system may output an alert. The alert may be associated with a mitigation procedure defined before the start of the trial.

This disclosure describes a method comprising receiving, at a computer system, before a start of a trial of a medical therapy, data that configure the computer system to detect alert conditions indicative of occurrences of failure modes identified as being potentially associated with the trial. The method also comprises receiving, at the computer system, trial data generated during conduct of the trial. In addition, the method comprises detecting, by the computer system based on the trial data, that one of the alert conditions has occurred, the alert condition indicative of an occurrence of a given one of the failure modes. The method also comprises outputting, by the computer system in response to detecting that the alert condition has occurred, an alert associated with a mitigation procedure defined for the given failure mode before the start of the trial. The mitigation procedure indicates a procedure to mitigate the occurrence of the given failure mode.

This disclosure also describes a computer system that comprises one or more processing units that are configured to receive, before a start of a trial of a medical therapy, data that configure the computer system to detect alert conditions indicative of occurrences of failure modes identified as being potentially associated with the trial. The one or more processing units are also configured to receive trial data generated during conduct of the trial. In addition, the one or more processing units are configured to detect, based on the trial data, that one of the alert conditions has occurred, the alert condition indicative of an occurrence of a given one of the failure modes. The one or more processing units are also configured to output, in response to detecting that the alert condition has occurred, an alert associated with a mitigation procedure defined for the given failure mode before the start of the trial, the mitigation procedure indicating a procedure to mitigate the occurrence of the given failure mode.

This disclosure also describes a computer-readable storage medium that stores computer-executable instructions that, when executed, configure a computer system to receive, before a start of a trial of a medical therapy, data that configure the computer system to detect alert conditions indicative of occurrences of failure modes identified as being potentially associated with the trial. The instructions also configure the computer system to receive trial data generated during conduct of the trial. In addition, the instructions configure the computer system to detect, based on the trial data, that one of the alert conditions has occurred. The alert condition is indicative of an occurrence of a given one of the failure modes. The instructions also configure the computer system to output, in response to detecting that the alert condition has occurred, an alert associated with a mitigation procedure defined for the given failure mode before the start of the trial. The mitigation procedure indicates a procedure to mitigate the occurrence of the given failure mode.

The details of one or more examples of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a conceptual diagram that illustrates an example environment in which the techniques of this disclosure may be implemented.

FIG. 2 is a flowchart that illustrates an example operation performed by a sponsor of a trial of a medical therapy.

FIG. 3 is a flowchart that illustrates an example operation to prioritize failure modes associated with the trial.

FIG. 4 is a flowchart that illustrates an example operation performed in part by a computer system after the trial starts.

FIG. 5 is a flowchart that illustrates an example mitigation procedure.

FIG. 6 is a flowchart that illustrates an example failure analysis procedure.

FIG. 7 is a flowchart that illustrates an example intervention procedure.

FIG. 8 is a flowchart that illustrates an example closure procedure.

FIG. 9 is a flowchart that illustrates an example operation performed by a computer system.

FIG. 10 is a conceptual diagram that illustrates an example table for identifying failure modes.

FIG. 11 is a conceptual block diagram that illustrates an example configuration of a computer system.

FIG. 12 is a conceptual diagram that illustrates a first example table for risk designation.

FIG. 13 is a conceptual diagram that illustrates a second example table for risk designation.

FIG. 14 is a conceptual diagram that illustrates an example risk model.

FIG. 15 is a conceptual diagram that illustrates an example quality risk planning and management process.

FIG. 16 is a flowchart illustrating a first portion of an example monitoring plan.

FIG. 17 is a flowchart illustrating a second portion of the example monitoring plan of FIG. 16.

### DETAILED DESCRIPTION

The attached drawings illustrate examples. Elements indicated by reference numbers in the attached drawings correspond to elements indicated by like reference numbers in the following description. In the attached drawings, stacked elements indicate the presence of one or more similar elements. In this disclosure, elements having names that start with ordinal words (e.g., “first,” “second,” “third,” and so on) may not necessarily imply that the elements have a particular order. Rather, such ordinal words may merely be used to refer to different elements of a same or similar type.

This disclosure describes techniques performed by one or more computer systems to facilitate risk-based conduct of trials of medical therapies. As described in detail below, a sponsor may develop a medical therapy. In addition, the sponsor may plan a trial to test whether the medical therapy is safe and effective. As part of planning the trial, the sponsor may identify failure modes associated with the trial. Such failure modes may also be referred to as “risks.” The sponsor may also identify alert conditions associated with the failure modes and may define mitigation procedures to be performed when the alert conditions occur. Such mitigation procedures may also be referred to as “action plans.”

In addition to identifying the failure modes and alert conditions associated with the failure modes, the sponsor may assign priority classifications to the failure modes. The priority classification assigned to a failure mode may be based on how an occurrence of the failure mode may affect the desired endpoints of the trial. The sponsor may define the mitigation procedures based on the priority classifications assigned to the risks.

Subsequently, the sponsor may engage (e.g. hire) one or more investigators to conduct a trial of a medical therapy developed by the sponsor. In addition, the sponsor may engage one or more monitoring organizations (i.e., monitors) to monitor the investigators' conduct of the trial. After engaging the investigators and the monitors, the sponsor may start the trial. As the investigators conduct the trial, the investigators may provide trial data to a computer system. The investigators providing trial data to the computer system may be one way in which the computer system receives trial data generated during conduct of the trial.

Furthermore, before the trial begins, the sponsor or other entity may configure the computer system to detect predetermined risks associated with protocol, study endpoints, regulatory requirements, investigational product, study population or risk factors identified by the sponsor at study inception and based on the trial data generated during conduct of the trial, the computer system may generate an alert when an alert condition associated with a predetermined risk is met. When the computer system determines that one of the alert conditions has occurred, the computer system may output an alert to a mitigation team. In some instances, the mitigation team includes one or more of the sponsors, monitors, contract research organizations (CROs), and/or data management, safety, quality, compliance or regulatory staff. The alert may be associated with one of the previously-defined mitigation procedures. The mitigation team may perform the previously-defined mitigation procedure in response to receiving the alert. For instance, the mitigation team may conduct a site visit in response to receiving the alert. In this way, conduct of the trial may be based on the failure modes identified by the sponsor.

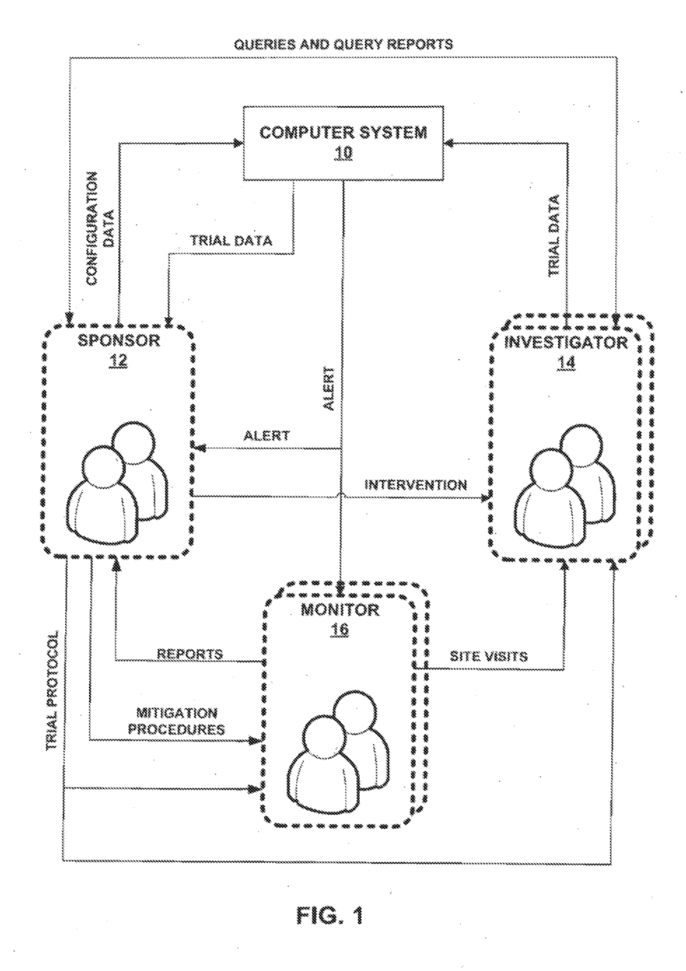

FIG. 1 is a conceptual diagram that illustrates an example environment in which the techniques of this disclosure may be implemented. In the example of FIG. 1, the environment includes a computer system 10, a sponsor 12, one or more investigators 14, and one or more monitors 16. In other examples, the environment may include more, fewer, or different organizations and systems. In the example of FIG. 1, sponsor 12, investigators 14, and monitors 16 are shown to include multiple persons to indicate that one or more persons may be associated with each of sponsor 12, investigators 14, and monitors 16.

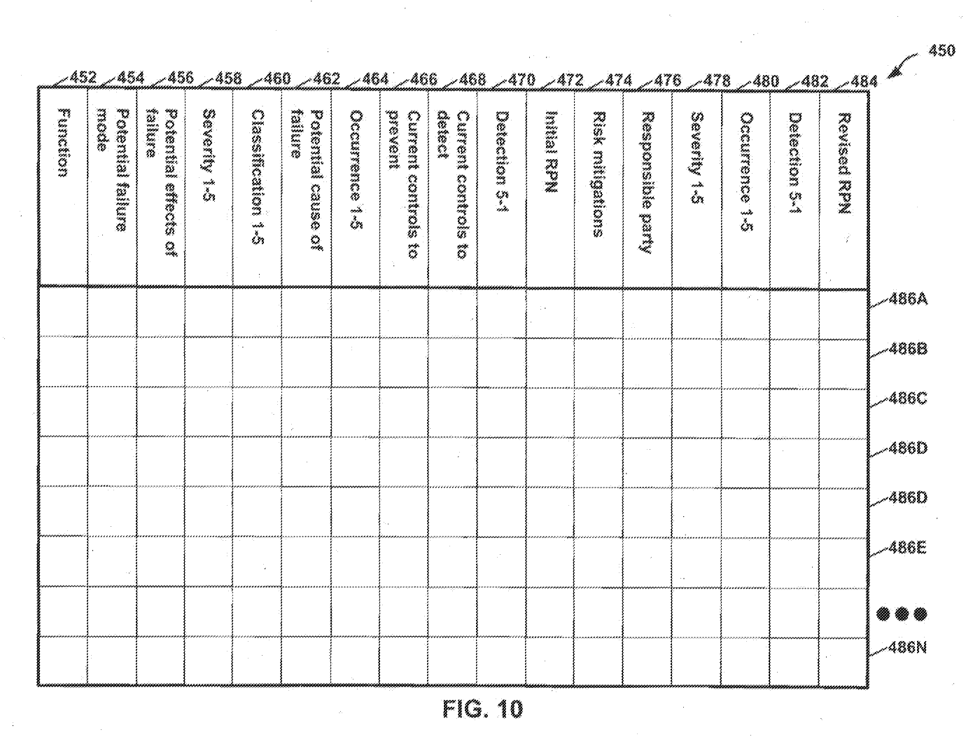

Computer system 10 includes one or more computing devices. For example, computer system 10 may include one or more server computers, personal computers, mainframe computers, storage devices, network devices, or other types of physical devices that process data. FIG. 10, described below, is a block diagram that illustrates example components of computing system 10. In some examples where computer system 10 includes more than one computing device, the computing devices of computer system 10 may be geographically dispersed.

In some examples, computer system 10 may appear, from the perspective of sponsor 12, investigators 14, and/or monitors 16, to exist in “the cloud,” i.e., as one or more devices interconnected and accessible via a network, such as the Internet. In other examples, computing devices of computer system 10 may be physically located at one or more sites associated with sponsor 12, investigators 14, and/or monitors 16.

Sponsor 12 develops a medical therapy. For example, sponsor 12 may develop a medical device, a drug, a biological compound, surgical procedure, or a new indication for an existing medical device, drug, or compound. Before sponsor 12 is allowed to bring the medical therapy to market, a regulatory agency may require sponsor 12 to prove that the medical therapy is safe and effective.

In order to prove to the regulatory agency that the medical therapy is safe and effective, sponsor 12 may sponsor a trial of the medical therapy. Sponsor 12 may sponsor various types of trials of the medical therapy. For example, sponsor 12 may sponsor a clinical trial, a non-clinical trial, a bench trial, or another type of investigation into whether the medical therapy is safe and effective. In some instances, a trial may be referred to as an investigation, a test, or a study.

In some examples, sponsor 12 may delegate the tasks of designing and conducting the trial to a third-party organization, such as a contract research organization (CRO). However, for ease of explanation, the remainder of this disclosure assumes that a sponsor of a trial designs and conducts the trial.

Certain problems may arise if sponsor 12 were to conduct the trial by itself. For instance, sponsor 12 may have a financial interest in proving that the medical therapy is safe and effective. For this reason, sponsor 12 may deliberately or unconsciously distort the results of the trial in order to show that the medical therapy is safe and effective.

To avoid the problems that may arise if sponsor 12 were to conduct the trial, sponsor 12 may engage (e.g., hire, contract with, etc.) one or more investigators 14 to conduct the trial on behalf of sponsor 12. Investigators 14 may be organizations that are independent of sponsor 12. In some instances, investigators 14 may be CROs.

Before investigators 14 start work on the trial, sponsor 12 may develop a study protocol. After developing the study protocol, sponsor 12 may provide the study protocol to investigators 14.

The study protocol may include one or more documents that describe the objectives, design, methodology, statistical considerations, and organization of the trial. For example, the study protocol may indicate what types of study subjects investigators 14 are to recruit, how to obtain consent from study subjects, what types of data to collect from study subjects, the length of the trial, and other details regarding the trial. The study subjects are persons who participate in the trial. Some of the study subjects may receive the medical therapy. Other study subjects are “controls,” meaning that such study subjects do not actually receive the investigational medical therapy. In some instances, study subjects may also be referred to as the “subjects” or “participants” of the trial.

The study protocol may include one or more case report forms (CRFs), trial questionnaires, subject diaries or similar data collection tools. Each of the CRFs may be a paper or electronic questionnaire or similar tool designed to collect trial data (i.e., data generated by conducting the trial). As investigators 14 conduct the trial, investigators 14 may enter trial data into the CRFs. A CRF (or sometimes a case record form) may be a printed, optical, or electronic document designed to record all required information to be reported to the sponsor for each study subject. In some instances, one or more items of an electronic CRF may be pre-populated (e.g., by computer system 10). Pre-populated items of an electronic CRF may be items that are part of the electronic CRF (or data collection device) that are not enterable/modifiable. These data may be stored in a study database. For example, a required item of an electronic CRF, such as “years” for an age question, may be pre-populated into the electronic CRF based on other data.

In the example of FIG. 1, investigators 14 may submit the trial data entered into the CRFs to computer system 10. Investigators 14 may submit the trial data to computer system 10 in various ways. For example, investigators 14 may use computing devices to electronically transmit the trial data to computer system 10. For example, investigators 14 may use their own computers to input the trial data into sponsor-provided CRFs. In this example, the investigator's computers may send the trial data on sponsor-provided CRFs electronically to computer system 10 or write the trial data to physical computer-readable storage media that are subsequently read by computer system 10. Thus, computer system 10 may receive the trial data directly or indirectly from investigators 14. Computer system 10 may receive and store the trial data generated by investigators 14 as part of investigators 14 conducting the trial on behalf of sponsor 12.

In some examples, sponsor 12 may receive trial data from computer system 10 during or after the trial. If sponsor 12 identifies particular types of issues in the trial data, sponsor 12 may send queries to investigators 14. For example, if sponsor 12 notices that a CRF includes potentially erroneous data (e.g., data indicating that a male study subject has ovarian cancer), sponsor 12 may send a query regarding the potentially erroneous data to investigators 14. Investigators 14 may send query reports to sponsor 12 in response to queries. However, to avoid undue interference by sponsor 12 in the trial, sponsor 12 may only be permitted to send limited types of queries.

There may be a variety of failure modes (i.e., risks) associated with the trial. Example failure modes may include factors that affect subject safety, issues associated with investigators 14 failing to comply with the study protocol or regulatory requirements, violations of the study protocol, adverse events associated with the medical therapy, and anomalies or discrepancies in trial data that may affect study outcomes. A violation of the study protocol (i.e., a protocol violation) may be a significant departure from processes or procedures that were required by the protocol. Protocol violations may result in data that are not deemed evaluable for a per-protocol analysis, and may require that the subject(s) who violate the protocol are discontinued from the study. A protocol violation may also occur if an investigator and/or study staff fail to follow the protocol, in such case data collected may be deemed non-evaluable.

In some examples, the failure modes associated with the trial may belong to various risk groupings. Example failure mode groupings may include, but are not limited to, such general categories including: administrative risks, facility-related risks, study team risks, patient safety risks, trial-related risks, central or core laboratory risks, study execution variance or deficiency risks, regulatory issues, adverse events, and documentation risks. An administrative risk may occur when there is a lack of qualified study personnel, when study execution expectations are not met, when there is a change in study personnel, a lapse in regulatory approval, and so on. A facility-related risk may occur when there is inadequate emergency support equipment, a lack of equipment required for protocol implementation (e.g., a −80° freezer), inadequate facility storage, a lack of research required standard operating procedures (SOPs), a lapse in a facility's regulatory approval, an inadequate quality system, and so on. Trial-related risks include inappropriate enrollment of study subjects, lost enrollments of study subjects, compromise of patient care, protocol noncompliance, and so on. Central or core laboratory risks may include missed or incomplete vendor audits, failures to provide normal reference ranges, changes of equipment without sponsor notification and updated validation of the equipment, a lack of compliance to laboratory standard operating procedures, low compliance for the timely processing of study data, and so on. Study execution variance or deficiency risks may include data quality issues, inadequate investigator oversight, record keeping problems, missing subject diaries, and so on. Regulatory issues may include missing IRB approval, inadequate process or reporting with IRB/IEC, inadequate site separation, failure to report change in investigator, missing regulatory forms, missing IRB/IEC communications, failure to follow conditions of approval imposed by IRB/IEC, IRB suspension, failure to update or maintain required reports, issues related to informed consent forms, the Health Insurance Portability and Accountability Act (HIPAA), assent, country-specific authorizations, and so on. Failure modes associated with adverse events may include failure to report adverse events, failure to report unanticipated adverse devices effects, reporting outside regulation expectations and so on. Documentation risks may include inadequate process or patient engagement in relationship to patient consent forms, inadequate or missing source data, and so on.

To help reduce the possibility of such failure modes occurring, sponsor 12 may select and engage one or more monitors 16. Monitors 16 may be individuals or organizations engaged to monitor the conduct of the trial. In general, monitoring may refer to methods used by sponsors, or CROs delegated responsibilities for the conduct of trials, to oversee the conduct of and reporting of data from the trials, including appropriate investigator supervision of the investigators' site staff and third-party contractors. In some examples, sponsor 12 may perform some or all of the tasks or roles described below with regard to monitors 16.

Sponsor 12 may use various criteria to select monitors 16. For example, sponsor 12 may choose monitors 16 based on educational qualifications, training and experience, as well as scientific or clinical knowledge.

As part of monitoring the conduct of the trial, monitors 16 may conduct site visits and provide reports to sponsor 12. The reports may indicate the activities and findings of monitors 16. The site visits may start with a site pre-qualification visit and continue through a final follow-up and close out visit. When monitors 16 conduct site visits, monitors 16 visit the physical sites where investigators 14 are conducting the trial (i.e., investigation sites). During such site visits, monitors 16 may monitor how investigators 14 are conducting the trial. In this way, monitors 16 may conduct on-site or “targeted” monitoring. In general, on-site monitoring refers to an in-person evaluation carried out at the investigation site or sites.

Furthermore, during site visits, monitors 16 may educate investigators 14 how to conduct various aspects of the trial. In some instances, monitors 16 may intervene to correct problems with how investigators 14 are conducting the trial. In some instances, monitors 16 may conduct in-person reviews of activities, focusing on review of source documentation of critical data elements and associated reporting processes to ensure that trial objectives are achieved. During such site visits, monitors 16 may also focus on elements impacting regulatory compliance, subject safety, and study objectives. In this way, monitors 16 may reduce the chances that the failure modes associated with trial will occur.

Because monitors 16 are in direct contact with investigators 14, monitors 16 may be in a position to influence the outcome of the trial. Thus, if monitors 16 had a financial interest in the outcome of the trial, monitors 16 could bias the outcome of the trial. Accordingly, monitors 16 may be independent of both sponsor 12 and investigators 14.

While site visits may reduce the occurrence of some of the failure modes associated with the trial, there may be several disadvantages to relying only on site visits to ensure that investigators 14 are conducting the trial correctly. For example, site visits may be expensive to conduct. In addition, frequent site visits may distract investigators 14 from conducting the trial.

Moreover, monitors 16 may not be able to detect all of the failure modes associated with the trial by conducting site visits. For example, a monitor may be unable to detect that an investigator is falsifying trial data because the monitor may not be aware the trial data generated by other investigators is substantially different.

In addition to using monitors 16 to monitor the conduct of the trial, sponsor 12 may use central monitoring to monitor the conduct of the trial. Central monitoring may also be referred to as off-site, adaptive or remote monitoring. Central monitoring shifts on-site monitoring activities and administrative tasks to a central resource, potentially enabling review of data in real time and potentially allowing better informed, actionable decisions to address system alerts in a timely manner. For example, central monitoring may allow trial data collected and entered at a trial site to be sent electronically to a central resource, such as a Clinical Trial Management System (CTMS). In this example, computer system 10 may be a CTMS that receives the trial data. Furthermore, in this example, in-house staff (e.g. monitors 16 or staff at sponsor 12) may review the data entries, generate queries, scrub data, and generate alerts. Example types of information that may be reviewed include, but are not limited to, contracts, clinical trial agreements, financial disclosure forms, curriculum vitae, laboratory normal reference ranges, protocol amendments, investigator brochures, operations manuals, laboratory manuals, informed consent forms, and documentation logs (e.g., for example shipping and receiving documents, site signature and initial training logs, etc.).

Using monitoring visit reports, a trial master file, study milestones, data mining and documentation of study specific performance indicators may allow remote monitors to identify early warning of risk situations. Establishing acceptable tolerance levels at study start up may ensure deviations are be detected and managed through query resolution by remote monitors with confirmation by the field monitor. Using electronic case report forms (eCRF) and CTMS systems as source of information provides the remote monitor with a view of data inconsistencies, unresolved queries, protocol deviations, delayed reports and overall study health in real time or within 24 hours.

In addition to or as an alternative to using on-site and/or central monitoring, sponsor 12 may use triggered monitoring to monitor the conduct of the trial. Triggered monitoring is a method of responding to risk observations, trend analysis, site performance issues, inconsistent data compared to other sites, outlier trends, anomalies, or system-generated alerts that may require immediate response. When sponsor 12 uses triggered monitoring, sponsor 12 and/or monitors 16 may respond to system-generated issues to improve site compliance, conduct retraining when appropriate, resolve discrepancies and initiate actions corresponding to identified failure modes.

In accordance with the techniques of this disclosure, sponsor 12 may implement a risk-based monitoring regime. Risk-based monitoring is an approach to monitoring that may use risk designation to determine monitoring intensity. Risk-based monitoring may use a combination of centralized and on-site monitoring to focus monitoring resources on study endpoints, subject safety, and other risk factors. A goal of risk-based monitoring is to increase an overall reliability of the trial data and to reassess the risk factors on a regular basis in order to ensure the overall quality and integrity of the trial data and subject safety. In some instances, risk-based monitoring may enable sponsor 12 to identify trends and data reporting errors in a way that is not possible by a single monitor review during an on-site monitoring visit at a single investigation site. The potential benefits of risk-based monitoring may include the ability to identify trends, anomalies, outliers across sites, improved productivity using electronic data collection systems to identify missing or incomplete data, real-time response to system-generated alerts, decreased travel costs, increased CRA productivity by focusing CRA activity on data verification and site performance, and so on.

Furthermore, risk-based monitoring may enable sponsor 12 to move some tasks conventionally performed at local investigation sites to one or more physical or virtual central sites (i.e., central hubs). By combining different monitoring models, sponsor 12 may be able to review and analyze both core (i.e., centralized) and non-core (e.g., local) elements of the trial in greater detail. Moving such tasks from local investigation sites to central hubs may provide several benefits. For example, moving such tasks from local investigation sites to central hubs may reduce in-cycle time through process optimization and leveraged technology. In another example, risk-based monitoring may enable sponsor 12 to use real time alerts, notifications, flags and escalation alerts for triggered responses. Risk-based monitoring may also minimize lags in data entry or redundant data entry using integrated systems and tools. Risk-based monitoring may also enable sponsor 12 to eliminate duplicate tasks and detect systematic data entry patterns or problems. Furthermore, risk-based monitoring may enable sponsor 12 to conduct performance analysis to predict future investigation site or investigator selection and patient accrual rates based upon past performance analysis. In another example, risk-based monitoring may enable sponsor 12 to improve quality through integration of predictive analytics and real time data analysis. In addition, risk-based monitoring may enable proactive decision-making through the use of escalations, and eliminate overlap in duplicative tasks.

Table 1, below, indicates example tasks that may be performed by on-site monitors and remote monitors.

TABLE 1

| On-site monitor | Remote monitor |
|---|---|
| Familiarity and adherence to monitoring | Track and manage data entry and query |
| plan (MP) | resolution process |
| Complete (SQV) site readiness | Track compliance with cycle time and |
| Conduct site initiation visit (ISV) | project milestones |
| Regulatory review of documents and | Conduct trend analysis of eCRF, site data |
| compliance | to mitigate risk (dropouts, errors, |
| Conduct on-site training | violations, missing data, etc.) |
| Clinical supplies management | Identify performance trends and alert |
| Device reconciliation and accountability | field monitor and study team to events |
| Complete on-site query resolution as | that cannot be resolved by remote |
| required | monitoring action |
| Management relationship with sites, | Conduct regular telephone monitoring |
| including timely enrollment, | visits to address outstanding |
| GCP/International Conference on | issues/queries, data entry discrepancies, |
| Harmonization (ICH) compliance, audit | site documentation and completion of |
| readiness, data quality, protocol and | training by site team members |
| regulatory compliance | Collect and review, archive regulatory |
| Schedule visits, prepare visit agenda, | documents |
| focus on monitoring action items, | Analyze key risk indicators (KRIs), key |
| confirm visit and follow-up via letters, | performance indicators (KPIS), study |
| compile site visit package | metrics and trends |
| Escalation of events that can be remotely | Monitor site visit follow-up to ensure |
| monitored or require sponsor action | completion |
| Respond to event adjudication triggers | Send out follow-up letters with |
| that cannot be resolved through remote | investigator acknowledgement |
| monitoring function | Support training and maintain clinical |
| Focus on critical study endpoints, safety | supplies |
| assessments, documentation surrounding | Proactive risk mitigation and event |
| adverse events, serious adverse events, | escalation to improve operational quality |
| UADEs | Consistency and completeness of data, |
| Maintaining study blind | unusual distribution ranges, outliers |

When sponsor 12 implements a risk-based monitoring regime, sponsor 12 may identify the failure modes (i.e., risks) associated with the trial. In addition, sponsor 12 describe each of the failure modes, describe the severity (i.e. criticality) of each of the failure modes, describe detection plans for each of the failure modes, describe safeguards against the occurrence of each of the failure modes, describe mitigation plans for each of the failure modes, and other information regarding the failure modes.

Sponsor 12 may define different detection plans for different types of failure modes. For example, sponsor 12 may define a detection plan for a given failure mode in which occurrences of the given failure mode are to be detected based on information collected during site visits that are to occur at particular intervals. The particular interval may be based on various factors, such as the severity of the risk, ease of detection, likelihood of occurrence, and so on.

In another example, sponsor 12 may define a detection plan for a given failure mode in which occurrences of the given failure mode are to be detected by computer system 10 based on an analysis of trial data entered by investigators 14. In this example, the detection plan may specify an alert condition associated with the given failure mode. The occurrence of the alert condition may be indicative of the occurrence of the given failure mode. For example, sponsor 12 may be sponsoring a trial of an implanted medical device that has a battery that can be recharged using an external induction coil. In this example, sponsor 12 may identify incorrect placement by investigators 14 of the external induction coil, e.g., relative to a corresponding internal coil, as a failure mode associated with the trial. In this example, computer system 10 may receive trial data indicating recharge rates of the devices and may determine that the failure mode has occurred when a median required battery recharge rate is greater than once per day.

As mentioned above, sponsor 12 may define mitigation procedures for each of the failure modes. The mitigation procedures may include instructions that mitigation teams are to follow when particular failure modes occur. In some instances, a mitigation procedure may indicate that a mitigation team is to intervene in the trial to mitigate the given failure mode. Continuing the example of the previous paragraph, the mitigation procedure may specify an action associated with incorrect placement of the induction coil. In this example, the mitigation procedure may include instructions that require monitors 16 to make telephonic inquiries about induction coil placement and to conduct site visits to retrain one or more of investigators 14 if needed.

The mitigation procedures may be tailored to the severity of the associated failure modes. For example, a mitigation procedure associated with a study subject safety risk may instruct a monitor (or another team associated with sponsor 12) to conduct an immediate on-site intervention. In another example, a mitigation procedure associated with a failure mode involving bookkeeping errors may simply instruct a monitor (or another team associated with sponsor 12) to send a reminder email to an investigator. In such examples, the mitigation procedures may be based on a complexity of the study protocol, the disease or medical therapy under study, the criticality of the trial population, experience of investigators 14, type and classification of the medical therapy (i.e., investigational product), potential risks, and results of an impact analysis of the trial.

After defining the detection procedures and mitigation procedures for the failure modes associated with the trial, sponsor 12 may configure computer system 10 to analyze trial data to detect the alert conditions associated with at least some of the failure modes. If computer system 10 determines, based on the trial data, that at alert condition has occurred, computer system 10 may output an alert associated with one of the pre-defined mitigation plans. In some examples, the alert may identify a failure mode, a severity of the failure mode, and a mitigation plan defined for the failure mode. In response to receiving the alert, monitors 16 or other mitigation teams may perform the mitigation procedures defined for the failure mode associated with the alert.

In some instances, the mitigation procedures defined for particular failure modes are to be performed by monitoring organizations (e.g., monitors 16, sponsor 12, etc.) and may involve monitoring how one or more of investigators 14 conducts the trial. In some examples, groups other than monitors 16 may partially or completely perform mitigation procedures defined for particular failure modes. For example, a given mitigation procedure may indicate that one of monitors 16 is to escalate a failure mode to a group within sponsor 12 if particular conditions occur. For instance, the monitor may escalate the failure mode to a safety assurance team, a data management team, a regulatory compliance team, or another group within sponsor 12.

In this way, a computer system (e.g., computer system 10) may receive, before a start of a trial of a medical therapy, configuration data that configure the computer system to detect alert conditions indicative of occurrences of failure modes identified as being potentially associated with the investigation. Furthermore, the computer system may receive trial data generated during conduct of the trial (e.g., by one or more investigators (e.g., investigators 14) as part of the one or more investigators conducting the trial on behalf of a sponsor (e.g., sponsor 12) of the trial). The computer system may detect, based on the trial data, that one of the alert conditions has occurred. The alert condition may be indicative of the occurrence of a given one of the failure modes. The computer system may output, in response to detecting that the alert condition has occurred, an alert associated with a mitigation procedure defined for the given failure mode before the start of the trial. The mitigation procedure may indicate a procedure to mitigate the given risk. For instance, the mitigation procedure may indicate that a mitigation team (e.g., one or more of monitors 16 or a team from sponsor 12) is to intervene in the trial to mitigate the given risk.

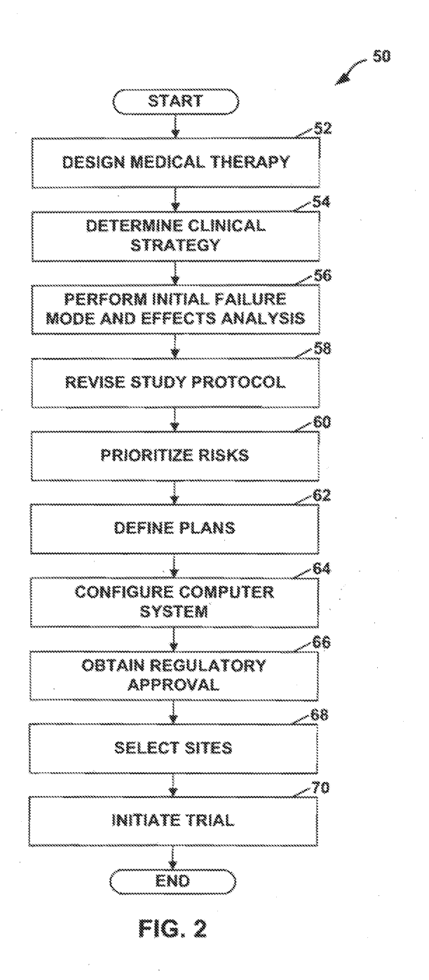

FIG. 2 is a flowchart that illustrates an example operation 50 performed by a sponsor of a trial of a medical therapy prior to the start of the trial. The sponsor may perform operation 50 to determine how to configure a computer system to ensure interoperability. Semantic interoperability is a property of a combined system containing two or more information systems such that specific aspects of the meaning of the information passed from one to the other are invariant over the data exchange that carries the information. In some examples, sponsor 12 (FIG. 1) may perform operation 50. In other examples, operation 50 may be performed by a CRO delegated by a sponsor or a designated vendor with information technology (IT)/data management capabilities meeting sponsor need. Nevertheless, for ease of explanation, this disclosure assumes that a sponsor performs operation 50.

After the sponsor starts operation 50, the sponsor designs a medical therapy (52). As part of designing the medical therapy, the sponsor may conduct various types of research regarding the medical therapy, select and analyze components of the medical therapy, conduct bench trials of the medical therapy, and so on.

In addition, the sponsor may determine a clinical strategy (54). As part of determining the clinical strategy, the sponsor may develop a study protocol, select and engage investigators (e.g., investigators 14), select and engage monitors (e.g., monitors 16), and perform other tasks associated with designing and preparing to implement a trial of the medical therapy. In some examples, the sponsor may start determining the clinical strategy after the sponsor has completed designing the medical therapy.

After the sponsor determines the clinical strategy, the sponsor may perform an initial failure mode and effects analysis (FMEA) (56). During the initial FMEA, the sponsor may identify failure modes associated with the trial (e.g., adverse event, regulatory non-conformance, data error, etc.). One goal in identifying the failure modes associated with the trial is to narrow the field of potential failure modes to those that are representative of a disease or condition under study, a product malfunction or failure, those having the greatest impact on the product being investigated, those most likely to be a target for a U.S. Food and Drug Administration (FDA) Bioresearch Monitoring (BIMO) inspection or audit, and so on. A BIMO program may be a US FDA program of on-site inspections to ensure the quality and integrity of the data submitted to the agency from regulated clinical trials of investigational drugs, devices, and biologics. Inspections may be made both in the U.S. and internationally at clinical investigator sites, Institutional Review Boards (IRBs), and sponsors (e.g. pharmaceutical, medical device, and biologic companies, including monitors and contract research organizations or CROs working under the sponsor). Inspections may be conducted by the following FDA Centers under the BIMO program: CDRH—FDA Center for Devices and Radiologic Health, CDER—FDA's Center for Drug Evaluation and Research, CBER—Center for Biologics Evaluation and Research, and CVM—FDA's Center for Veterinary Medicine.

Another goal in identifying the failure modes is for the sponsor to prepare for failure modes associated with the medical therapy is being used in a person for the first time, failure modes associated with an entirely new technology, whether the medical therapy is likely to have high visibility in the media or is likely to capture the attention of regulatory authorities.

In some examples, multiple groups within the sponsor may identify the failure modes associated with the trial. For instance, one or more business units, study teams, quality assurance teams, data management teams, safety assurance teams, and monitoring teams within the sponsor may identify the failure modes associated with the trial.

After performing the initial failure mode and effects analysis, the sponsor may revise the study protocol based on the identified failure modes (58). In some instances, the sponsor may revise the study protocol and identify failure modes multiple times.

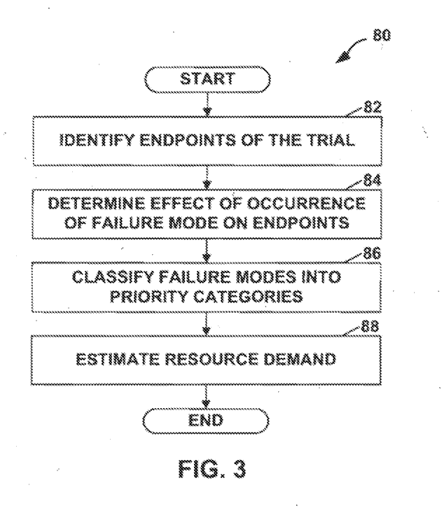

Next, the sponsor may prioritize the failure modes associated with the trial (60). For instance, the sponsor may assign priorities (e.g., low, medium, or high) priorities to the failure modes. Under each priority category are factors to be considered when establishing the level of monitoring intensity necessary to insure subject safety, protocol and regulatory compliance, data integrity and site compliance, good clinical practice (GCP) and standard operating procedure (SOP) compliance. The sponsor may prioritize the failure modes in various ways. FIG. 3, described in detail below, is a flowchart that illustrates an example operation to prioritize the failure modes associated with the trial.

In addition, the sponsor may use the identified failure modes to define one or more plans to implement various aspects of the trial (62). For instance, the sponsor may define a data management plan, a data quality plan, a monitoring plan, a safety plan, a quality plan, a statistical analysis plan, and/or other plans to implement various aspects of the trial. The data management plan may indicate how the sponsor intends to manage data associated with the trial. The data quality plan may indicate how the sponsor intends to ensure the quality of the data associated with the trial. The monitoring plan may indicate how monitoring will be conducted for the trial. The monitoring plan may include monitoring procedures associated with various alerts and risks. The safety plan may indicate how the sponsor intends to ensure safety during the trial. The quality plan may indicate how the sponsor intends to audit the trial data to ensure regulatory compliance and to ensure that the trial produces quality data. The statistical analysis plan may indicate how the sponsor intends to conduct a statistical analysis on the trial data. The data management plan, the data quality plan, the monitoring plan, the safety plan, the quality plan, and the statistical analysis plan may be “deliverables,” in that these plans may be formally delivered to a regulatory entity or another type of entity.

The monitoring plan may be a formal document that establishes the extent and nature of monitoring for the trial. In some examples, the monitoring plan may serve as a foundation for budget forecasting, resource allocation and risk mitigation considerations. In some examples, the monitoring plan may be separate or may be included in a clinical investigational plan.

The monitoring plan may include detection procedures and mitigation procedures for the identified failure modes. For example, the monitoring plan may indicate detection procedures for source data verification based on a range of considerations. Such considerations may include trial objectives, trial design and complexity, trial size and number of investigation sites, critical data points and safety considerations, trial endpoints, subject criticality, data verification, and so on. Data verification may include verification of subject eligibility criteria, patient informed consent, randomization, blinding/masking, treatment schedules, visit content, device accountability, safety issues and reporting, and so on. When developing the monitoring plan, sponsor 12 may review the trial protocol, safety procedures, anticipated enrollment and assessment, and resource demands.

Furthermore, the monitoring plan may identify required site visits as part of the detection procedures for one or more of the failure modes. The required site visits may include one or more on-site or remote pre-trial qualifications visits, one or more site initiation visits, one or more interim monitoring visits, and one or more trial close out visits. During a pre-trial qualification visit, the sponsor and/or monitors may confirm the acceptability of a site according to sponsor guidelines and regulatory requirements.

In addition, the monitoring plan may indicate who will perform the monitoring, qualifications of monitors and documentation of experience, criteria for determining timing and frequency of monitoring visits, regulatory and study management documents to be reviewed based on study risk designation and subject safety issues, amount and type of subject data to be monitored (i.e., the monitoring intensity), the number of data points per CRF page requiring source document verification, tools used to monitor the trial (e.g. checklists, logs, reports, communications, equipment, etc.), documents, medical reports, reports, assays, radiographs or other media used as source documents to be reviewed, and other information about how to conduct monitoring of the trial.

The sponsor may consider various factors when determining the monitoring intensity. For example, the sponsor may consider the quality and confidence in data, financial impact and impact on a business unit. If monitoring is inadequate, the downside may be an inability to confirm quality of data, an increased risk of audit findings, potential for unusable data for issues identified too late due to resource constraints, inability to secure successful submission, or confidence in publication in which full assurance and confidence in data may be at risk.

The sponsor may identify various detection procedures for different failure modes. For example, the sponsor may identify on-site visits or data analysis by a computer system (e.g., computer system 10) as procedures for detecting the occurrences of the failure modes. In examples where the process for detecting a failure mode involves on-site visits, the sponsor may determine levels and frequencies (i.e., the intensity) of the on-site visits. In some instances, more severe failure modes may entail greater need for safety, quality and monitoring intensity and focus.

The sponsor may determine the intensity of the on-site visits in various ways. For instance, some failure modes may involve discrepancies between the trial data entered by different investigation sites. In this example, the sponsor may use a statistical formula that may demonstrate, with 95% confidence, the likelihood of discrepancies at one of the investigation sites. In this example, the sponsor may assume that a proportion of study subjects with no unreported events is 90%, plus or minus a 5% confidence interval. The sponsor may generate a random sample chart and conduct a CRF review to determine the possible need for triggered monitoring of the failure mode. Sampling may be based on a proportion number of study subjects enrolled at an investigation site. The point estimate of the population rate may be the average of the estimated rate for an investigation site. The standard error of the population estimated may be the sample standard deviation of the overall-per-site rates, divided by the square root of the number of sites sampled. A standard deviation of per-site error rate may be approximately 15% but the sponsor may determine a more accurate percentage by establishing a site-to-site variability rate of 5% or less. If site variation is greater than 15%, then the sponsor may escalate the number of CRF reviews used to monitor for occurrence of the risk.

The sponsor may use the following metric to establish percentages of discrepancies:

number of patients with 0 unreported events÷number of charts reviewed=% of likely discrepancies

The sponsor may then compute success rate based on the total number of charts that have been monitored. A two-sided 95% confidence interval is then computed based upon the observed rate. If the lower bound is equal to 90% or more, the sponsor may assume a confidence level of data integrity. If the confidence interval is below 90%, then a mitigation procedure should be implemented (e.g. increase the number of monitoring visits and site conferences with the investigators to identify deficiencies, repeat site training, etc.) or take appropriate action based upon findings.

In addition to assessing site-to-site variability error rates, the detection procedure for a failure mode may involve on site monitoring or a computer system reviewing CRF forms against established acceptable quality levels (AQL), normal reference ranges or source documents for major errors. A threshold of five major errors (5 errors per 15 charts reviewed) may indicate a need for expanding chart review (e.g., increased monitoring). However, if the error detection rate is in the range of 2-4 errors per 15 charts, while nominally higher than an error rate of 10%, this error detection rate is not statistically different (<0.05, one sided interval) from the goal error rate of 10% or less. Depending upon the errors detected, on site visits and chart review may be triggered based on the results of quality signal detection activities.

The detection procedures for other failure modes may involve detection of particular events. The mitigation procedures for the failure modes may be triggered when the particular events occur. For example, a mitigation procedure may be triggered when a computing system performs an aggregate statistical analysis that shows that a particular investigation site is an outlier relative to other investigation sites in terms of adverse event reporting. In another example, a mitigation procedure may be triggered when data anomalies occur at higher frequency rate than anticipated. In another example, a mitigation procedure may be triggered when site monitoring visits indicate inadequate investigator oversight, problems with site performance, or issues of potential non-compliance. In another example, a mitigation procedure may be triggered when site monitoring visit reports indicate inadequate investigator oversight or problems with site performance or issues of potential non-compliance. In yet another example, a mitigation procedure may be triggered when the computer system detects violation of the informed consent process, site staff failure to report adverse events, severe adverse events, protocol violations, or lapses in IRB or independent ethics committee (IEC) approval. Under FDA regulations, an IRB is an appropriately constituted group that has been formally designated to review and monitor biomedical research involving human subjects. In other countries, a similarly constituted group may be known as an Ethical Review Board, an IEC, etc.

In another example, a mitigation procedure may be triggered when an investigation site having a high probability of experiencing a failure mode has particular condition. Such conditions may include unusual enrollment (faster/slower than other sites), higher or lower rates of adverse events, higher or lower rates of non-compliance, or sudden changes in enrollment. High-risk data might be a particular type of event or outcome that is indicative of a problem with the study. For example, a high rate of post-procedure embolism might indicate a poorly trained investigator or a problem with subject selection. Any new investigation site in a trial start-up phase may be high risk until performance and compliance can be confirmed.

As part of identifying the failure modes associated with the trial, the sponsor may generate one or more risk assessment documents. In some examples, the risk assessment documents may be of the type described by International Organization for Standardization (ISO) standards no. 14971 and/or 14155.

The risk assessment documents may identify some or all areas where there is potential for risk due to mechanical, electrical, environmental, logical, user and biological issues for the medical therapy and the trial of the medical therapy. Mechanical risks may include risks of clinical outcomes caused by mechanical faults of the medical therapy. For instance, mechanical faults may include risks caused by broken pans, electrical shocks, and the like. Environmental risks may include risks of clinical outcomes caused by interactions between the medical therapy and an environment in which the medical therapy is used. For instance; environmental risks may include risks of clinical outcomes caused by interactions with other therapies, light, food, electromagnetic fields, temperature, pressure, and other factors in the environment of a user of the medical therapy. Example user-derived risks may include risks of clinical outcomes caused by a user of the medical therapy. For instance, user-derived risks may include risks associated with failing to follow dosage instructions, risks associated with the user improperly handling the medical therapy, and so on. Non-user events may include risks caused by people or things other than a user of the medical therapy. For instance; non-user events may include risks associated with a caregiver failing to follow instructions, electrical power failures, programming faults, and other events that are not caused by the user or the user's environment. Biological risks include risks of infection, cancer, adverse immune system response, and the like.

In some examples, a risk assessment document may include a table. Each row of the table may correspond to a different failure mode. The columns of the table may include a function column, a risk description column, an effects column, a severity column, a cause column, an occurrence column, a detection column, a risk priority number (RPN) column, an acceptability column, a safeguard column, and a verification method column. Cells in the function column may indicate functions of the medical therapy or the trial. Cells in the failure mode description column may indicate failure mode descriptions that describe the failure modes. Cells in the effects column may indicate effects of the failure modes occurring. Cells in the severity column may indicate severity scores for the failure modes. Failure modes with higher severity scores are anticipated to have more severe effects than failure modes with lower severity scores. Cells in the cause column may indicate potential causes of the failure modes. Cells in the occurrence column may indicate occurrence scores for the failure modes. Failure modes with higher occurrence scores are anticipated to be more likely to occur than failure modes with lower occurrence scores. Cells in the detection column may indicate detection scores for the failure modes. Failure modes with higher detection scores are anticipated to be less detectable than failure modes with low detection scores. Cells in the RPN column may indicate RPNs for the failure modes. The RPN of a failure mode may be equal to the value that results from multiplying the severity, occurrence, and detection scores of the failure mode. Cells in the acceptability column of the table may indicate whether occurrence of the failure mode is or is not acceptable. Cells in the safeguard column may indicate safeguards designed to prevent the occurrence of the failure modes. Cells in the verification method column of the table may indicate methods for verifying whether the failure modes have occurred. FIG. 10, described in detail below, illustrates an example table for identifying failure modes.

Furthermore, the sponsor may configure a computer system (e.g., computer system 10) to detect alert conditions and to output alerts (64). The sponsor may configure the computer system in various ways. For example, the sponsor may develop data validation programs that, when executed by the computer system, cause the computer system to identify invalid trial data. For example, study subjects in the trial may all be elderly and the trial data may indicate study subjects' birthdays. In this example, the computer program may identify an error in the trial data if a study subject's birthday indicates that the study subject is a child. Particular types of invalid trial data may be associated with alert conditions for the identified failure modes.

In another example, a statistical analysis software package may be installed on the computer system. In this example, the sponsor may develop computer programs (e.g., scripts) that can be run using the statistical analysis software package. Such computer programs may cause the statistical analysis software packet to perform statistical analyses to identify patterns or trends within the trial data. Particular patterns or trends within the trial data may be associated with alert conditions for the identified failure modes.

In addition, the sponsor may obtain regulatory approval to conduct the trial (66). In some instances, the sponsor may obtain regulatory approval based on a description of the trial, including a description of the risk and rationales for taking the risks. Furthermore, the sponsor may perform site selection and engage investigators (68).

After the sponsor configures the computer system, the sponsor may initiate the trial (70). For instance, the sponsor may instruct investigators who have met regulatory requirements and received IRB/IEC approval (e.g., investigators 14) to begin the trial. Thus, after the sponsor has identified the failure modes associated with the trial, identified the types and potential severities of the failure modes, determined how occurrences of the failure mode will be minimized, determined how the failure modes are justified in relation to the expected benefits, and after regulatory approvals are obtained, the sponsor may select sites and commence execution of the trial.

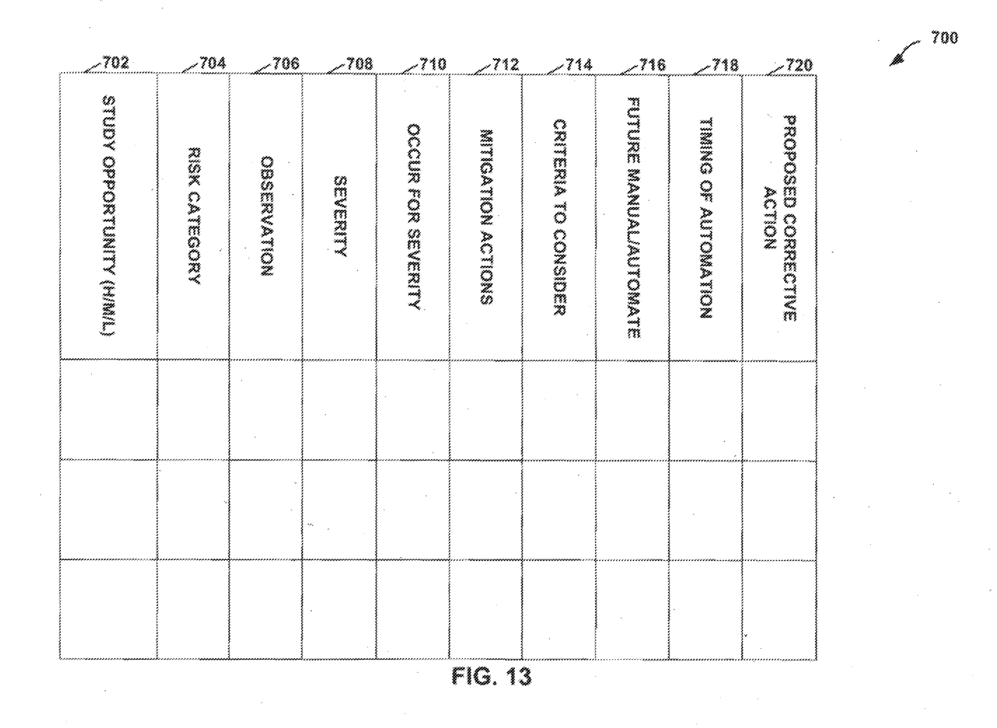

FIG. 3 is a flowchart that illustrates an example operation 80 to prioritize the failure modes associated with a trial. A sponsor of the trial (e.g., sponsor 12) may perform operation 80 before the start of the trial. The sponsor may enter information into table 700 (FIG. 13) when categorizing failure modes prior to the start of a trial. The sponsor may generate table 700 at the start of a trial to identify potential signal alerts which may be embedded in the database, triggered when acceptable quality levels (AQL) is out of scope and would require action to resolve.

To prioritize the failure modes, the sponsor may first identify one or more endpoints of the trial (82). The endpoints of the trial may include the desired goals for the trial. For example, the endpoints for the trial may include determining whether the medical therapy is safe, determining whether the medical therapy is effective, finishing the trial within a particular time frame or within a particular budget, and so on.

After identifying the endpoints, the sponsor may conduct an impact analysis that determines how the occurrence of the failure modes may affect the end points (84). Based on the impact analysis, the sponsor may assign priorities to the failure modes based on the likelihoods that occurrences of the failure modes will prevent the endpoints from occurring.

The impact analysis may determine the percentage of trial data to review in order to detect the occurrence of the failure modes. In addition, the impact analysis may determine the frequency and timing of monitoring visits to detect and/or prevent the occurrence of the risks. The impact analysis may identify data that are critical to the reliability of trial findings, such as primary, secondary, and tertiary end points, serious adverse events that may result in trial termination, blinding issues, subject eligibility, event adjudication and human subject protections.

In another example, one or more of the failure modes may involve data discrepancies. As part of the impact analysis, the sponsor may determine whether the data discrepancies are major or minor. Major errors are discrepancies that could reasonably impact regulatory compliance, study endpoints, centralized monitoring trends, signal detection activities, or subject safety. Examples may include missing or incorrectly executed informed consent from study subjects, unreported adverse events, and missing or non-existent protocol required procedures, protocol violations or inconsistent data. Minor discrepancies may not impact regulatory compliance, study objectives or subject safety but should be addressed and documented during on-site monitoring visits. Examples of minor discrepancies may include failure to complete query resolution in timely manner, delayed communication or correspondence, and out of window visits without supporting documentation.

The sponsor may then classify, based on the impact analysis, the failure modes into priority categories (86). In other words, the impact analysis may serve as an initial assignment tool that aids in establishing a priority categorization based on study impact and predicator variables.

In some examples, the sponsor may consider various factors when classifying a failure mode into a priority category. Such factors may include quality or confidence in the data, potential for unusable data, financial impact, impact on monitoring quality and subject safety, impact on study milestones, identification of potential problems with the trial protocol, procedure or product, the level of study importance to a business unit, the impact of the failure mode on meeting pre-defined deadlines, impact on regulatory submissions, impact of quality problems on labeling claims, and so on.

In addition to considering the impacts of the failure modes on the endpoints of the trial, the sponsor may consider various factors of the trial when determining how to classify the failure modes. For instance, the sponsor may be more likely to classify a failure mode into a high priority category if one or more of the following criteria apply to the trial: lack of product performance history, potential of harm to patient if product fails, new technology, first in man study, high media visibility or public relations interest, FDA required condition of approval study, investigational device exemption (IDE) extension, risk of regulatory audit, resource gaps, inadequate monitoring resources to cover designated visits per monitoring plan, expanded or amended indication, feasibility study or concept validation for pilot, new treatments or existing or new conditions, inability to conduct fixed sampling schedule, high volume single investigation site, high level site variability compared to other investigation sites, high morbidity/mortality within study population, vulnerable subject population, pediatric subjects, intense study timelines, and large complex global studies.

The sponsor may be more likely to classify a failure mode into a medium priority category if one or more of the following criteria apply to the trial: the trial is an IDE continued access study, the trial is an IDE extension on a proven product with history of low risk, the trial is being conducted by a new investigator or investigation site with no prior research history, the trial is being conducted by an investigator or investigation site with prior history of receiving FDA form 483, the trial is a National Institutes of Health (NIH) sponsored study, the trial involves protocol amendments, there have been changes to the investigator brochure or operations manual, the trial involves characterization of product performance, the trial involves an investigation site with high staff turnover, a change of Principal Investigator occurs during the trial, new regulatory guidelines are implemented before or during the trial, the trial involves preparation for open label extension, the trial is a feasibility platform for a future study (e.g. use in chronic disease population), the trial is an investigator initiated study, the trial is a physician initiated trial, and the trial is a physician sponsored study, or the trial is an external research program. These factors may be reviewed and discussed with a study team, account managers, clinical directors, quality, safety, and monitoring and data management to determine a priority classification (i.e., a risk designation).

The sponsor may be more likely to classify a failure mode into a low priority category if one or more of the following criteria apply to the trial: the trial is a seeding or market driven study, the trial is an observational study, the trial is a registry study, the trial is an assessment of an off-label use of a product, the trial does not involve safety data collection.

In other examples, the sponsor may associate each failure mode with a priority score prior to the start of the trial. Mitigation procedures defined for one or more of the failure modes associated with higher priority scores may involve greater monitoring intensity than mitigation procedures defined for those with failure modes associated with relatively lower priority scores. Failure modes with low priority scores may be considered low priority failure modes while failure modes with high priority scores may be considered high priority failure modes.

In this example, the computer system may be programmed in a manner that identifies and stores the priority scores associated with the failure modes. Furthermore, the computer system may output indications of the priority scores. For instance, when the computer system detects the occurrence of an alert condition for a given failure mode, the computer system may output an alert that indicates the priority score associated with the given failure mode. In other instances, the computer may output indications of the priority scores in response to other events, such as in response to requests sent by sponsor 12 or monitors 16.

In this example, the sponsor may assign a priority score of “1” to a failure mode if occurrence of the failure mode relates to a routine error associated with a non-core element of the trial. In some instances, the sponsor may assign a priority score of “1” to a failure mode if an occurrence of the failure mode may be resolved via an automated query to one or more investigator sites and correction of the failure mode may be confirmed through routine monitoring visits. That is, if the failure mode has a first priority score, the mitigation procedure associated with the alert may involve a routine site visit.

The sponsor may assign a priority score of “2” to a failure mode if the failure mode has a relatively low impact on a non-core element of the trial. A core element may be a critical data point that has a direct impact on study endpoints. A non-core element may be a data point that does not impact study endpoints and may be of an administrative nature. For instance, the sponsor may assign a priority score of “2” to a failure mode if mitigation of an occurrence of the failure mode requires communication with an investigation site to determine an extent and impact of the occurrence, but the occurrence may generally be managed during an Interim Monitoring Visit (IMV). That is, if the failure mode has a second priority score, the mitigation procedure associated with the alert may involve routine monitoring to determine an extent and impact of the occurrence of the given failure mode.

The sponsor may assign a priority score of “3” to a failure mode if occurrence of the failure mode has a moderate impact on a core element of the trial. For instance, the sponsor may assign a priority score of “3” to a failure mode if mitigation of an occurrence of the failure mode requires review and analysis by the sponsor and/or a monitoring team. Furthermore, mitigation of the occurrence may involve obtaining clarification of the occurrence from an investigation site. Mitigation of the occurrence may also involve one or more required responses. However, the sponsor and/or monitors may generally be able to resolve the occurrence through routine monitoring visits. In some examples, monitors may escalate the occurrence to one or more teams at the sponsor based on the monitor's findings, the monitor's ability to verify responses from the investigators and the acceptability of the responses from the investigators. That is, if the failure mode has a third priority score, the mitigation procedure associated with the alert may involve a determination of the extent and impact of the occurrence of the given failure mode and a determination of whether escalation to a sponsor of the trial is required.

The sponsor may assign a priority score of “4” to a failure mode if occurrence of the failure mode has a relatively high impact on a core element of the trial. For instance, the sponsor may assign a priority score of “4” to a failure mode if an occurrence of the failure mode would require communication with an investigation site to secure additional information, a scheduled monitoring visit, and/or escalation based on observed findings and the nature of the failure mode. That is, if the failure mode has the fourth priority score, the mitigation procedure associated with the alert may involve securing additional information about the occurrence of the failure mode, conducting a monitoring visit, and determining whether escalation to the sponsor of the trial is necessary.

The sponsor may assign a priority score of “5” to a failure mode if occurrence of the failure mode has a very high impact on a core element of the trial. For instance, the sponsor may assign a priority score of “5” to a failure mode if an occurrence of the failure mode may affect subject safety, a regulatory submission or application, has a high impact on a business unit's program, requires an immediate response to ensure subject safety, and/or requires an immediate response to ensure regulatory or trial protocol compliance. Failure modes assigned a priority score of “5” may require documentation and immediate resolution. In some instances, failure modes assigned a priority score of “5’ are likely to disrupt trial conduct or subject safety in a way that requires immediate escalation to the sponsor. That is, if the failure mode has a fifth priority score, the mitigation procedure associated with the alert may involve immediate intervention.

After categorizing the failure modes into priority categories, the sponsor may estimate resource demands for the failure modes based on the priority categories of the failure modes (88). For instance, the sponsor may forecast what resources will be required to detect and mitigate the failure modes. The sponsor may develop a monitoring plan based on the estimated resource demands. When building a forecast, the sponsor may capture the following information: fiscal year, study name and protocol number, risk designation, anticipated study start date, first patient entered, last patient visit, projected database lock, number of monitoring trips planned, a full time equivalent (FTE) capacity required to meet projected demand, trip capacity and resource gap.

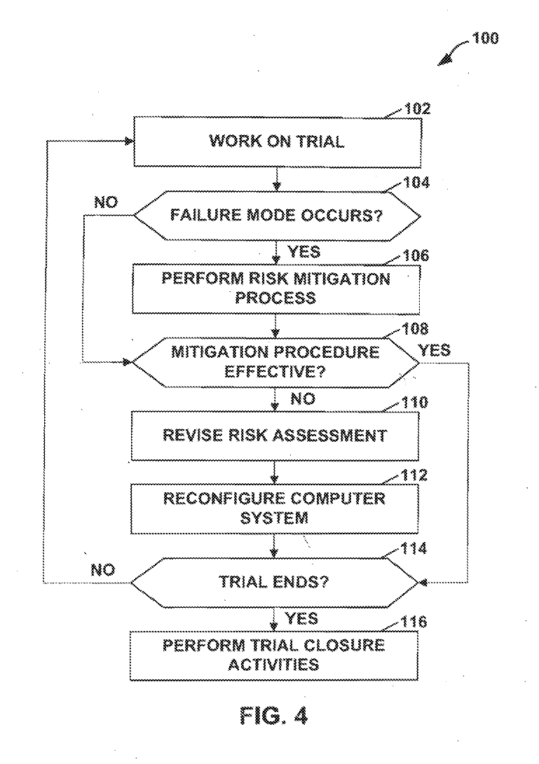

FIG. 4 is a flowchart that illustrates an example operation 100 performed in part by a computer system after the trial starts. After operation 100 begins, one or more investigators (e.g., investigators 14) work on the trial (102). During the trial, it is determined whether a failure mode has occurred (104). The occurrences of various types of failure modes can be determined in various ways. For example, a computer system (e.g., computer system 10) may analyze trial data and detect, based on the trial data that an alert condition associated with a failure mode has occurred. The alert condition may be indicative of the occurrence of the failure mode. In another example, monitors 16 and/or sponsor 12 may determine that the failure mode has occurred.

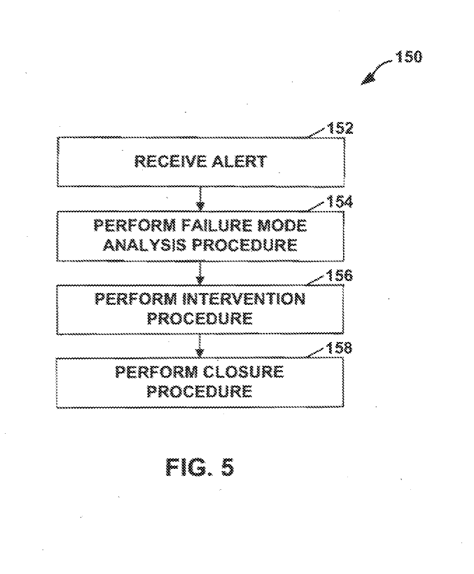

In response to determining that the failure mode has occurred (“YES” of 104), a mitigation procedure defined for the failure mode can be performed (106). Various parties may perform the mitigation procedure defined for the failure mode. For example, monitors 16 may perform some or all of the mitigation procedure. In another example, one or more teams within sponsor 12 may perform some or all of the mitigation procedure. FIG. 5, described in detail below, is a flowchart that illustrates an example mitigation procedure.

After the mitigation procedure has been performed, a determination is made whether the mitigation procedure effectively resolved the occurrence of the failure mode (108). In other words, it may be determined whether the mitigation procedure resolved the failure mode and was sufficient to reduce the probability of the failure mode recurring in the future.

Various parties may determine whether the mitigation procedure was effective. For example, if the failure mode relates to a data management issue, a data management team at the sponsor or sponsor designee may determine whether the mitigation procedure was effective. In another example, if the failure mode relates to a safety issue, a safety team at the sponsor may determine whether the mitigation procedure was effective.

If it is determined that the mitigation procedure was not effective, a risk assessment for the failure mode may be revised (110). Revising the risk assessment for the failure mode may involve revising the mitigation procedure for the failure mode, revising a detection procedure for the failure mode, revising a severity score for the failure mode, revising a priority classification for the failure mode, revising an occurrence score for the failure mode, revising a detectability score for the failure mode, or revising other aspects of the risk assessment for the failure mode. Revising the detection procedure for the failure mode may involve revising an alert condition for the failure mode.

Various parties may revise the risk assessment for the failure mode. For example, if the failure mode relates to a data management issue, a data management team at sponsor 12 may revise the risk assessment. In another example, if the failure mode relates to a regulatory compliance issue, a regulatory compliance team at sponsor 12 may revise the risk assessment.

After revising the risk assessment in step 110, the computer system may be reconfigured based on the revised risk assessment (112). For example, a computer program executed by the computer system to detect the occurrence of the failure mode may be rewritten based on a revised detection plan in the revised risk assessment for the failure mode.

Various groups may reconfigure the computer system based on the revised risk assessment. For example, the sponsor may reconfigure the computer system based on the revised risk assessment. In another example, the sponsor may delegate the task of reconfiguring the computer system to one or more other parties, such as a data management vendor or an IT service organization.

After reconfiguring the computer system or after determining that the mitigation procedure was effective (“YES” of 108), it is determined whether the trial has ended (114). If the trial has ended (“YES” of 108), trial closure activities may be performed (116). The trial closure activities may include reviewing results, evaluating performance of investigators, preparing reports, submitting applications, and so on.

Various groups may perform the trial closure activities. For example, the sponsor may perform some or all of the trial closure activities. In another example, the sponsor may delegate one or more of the trial closure activities to one or more other parties, such as monitoring organizations, independent contractors or auditors.

On the other hand, if the trial has not yet ended (“NO” of 114), the investigators may continue work on the trial (102). During the trial, it may be determined whether mitigation procedures are effective (108), even if no failure mode occurs. For instance, if no failure more occurs (“NO” of 104), the sponsor may still determine whether the mitigation procedures are effective (108). For example, sponsor 12 may periodically determine, during the trial, whether mitigation procedures for various failure modes are effective.

In this way, the computer system may receive, after the start of the trial, additional data that reconfigure the computer system to detect additional alert conditions. The additional alert conditions may be indicative of occurrences of the failure modes or additional failure modes identified as being potentially associated with the trial. In some instances, the computer system may receive the additional data on a periodic basis during the trial.

FIG. 5 is a flowchart that illustrates an example mitigation procedure 150. In mitigation procedure 150, a mitigation team receives an alert (152). The alert may be associated with a failure mode identified as being potentially associated with the trial.

The mitigation team may receive the alert from various sources. For example, the mitigation team may receive the alert from a computer system, such as computer system 10 (FIG. 1). In another example, the mitigation team may receive the alert from one or more monitors, such as monitors 16. In another example, the mitigation team may receive the alert from one or more investigators, such as investigators 14.

The mitigation team may include various groups of people. For example, the mitigation team may include one or more monitors. In another example, the mitigation team may include a safety team, a data management team, a quality assurance team, and/or another group of one or more people within sponsor 12. Sponsor 12 may identify, before the trial starts, the appropriate mitigation teams to receive alerts associated with particular failure modes.

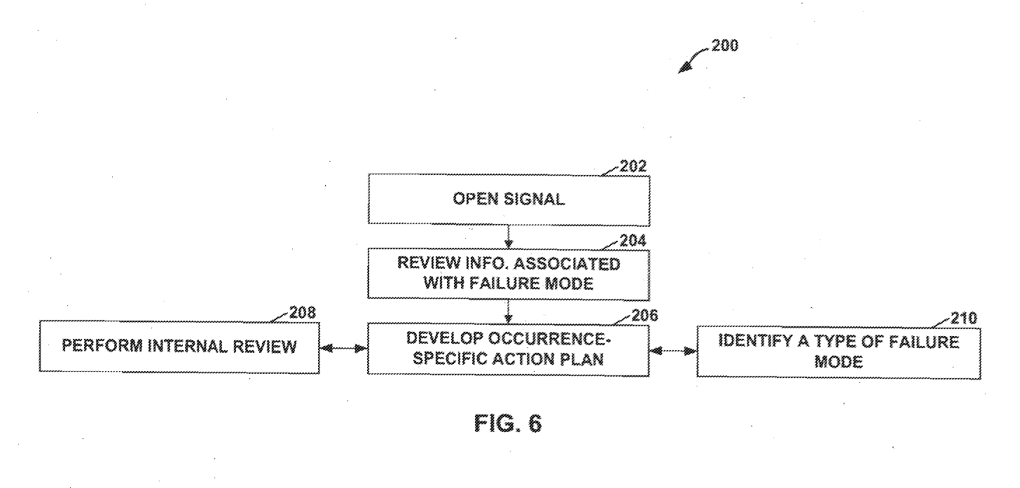

After receiving the alert, the mitigation team may perform a failure mode analysis procedure (154). By performing the failure mode analysis procedure, the mitigation team may gather and analyze information about the occurrence of the failure mode. In addition, the mitigation team may develop a plan to respond to the specific occurrence of the failure mode. FIG. 6, described in detail below, is a flowchart for example failure mode analysis procedure.

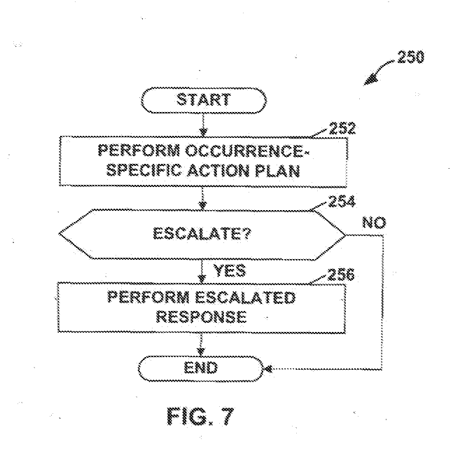

After performing the failure mode analysis procedure, the mitigation team may perform an intervention procedure (156). When the mitigation team performs the intervention procedure, the mitigation team may intervene in how one or more of the investigators are conducting the trial. FIG. 7, described in detail below, is a flowchart for an example intervention procedure.

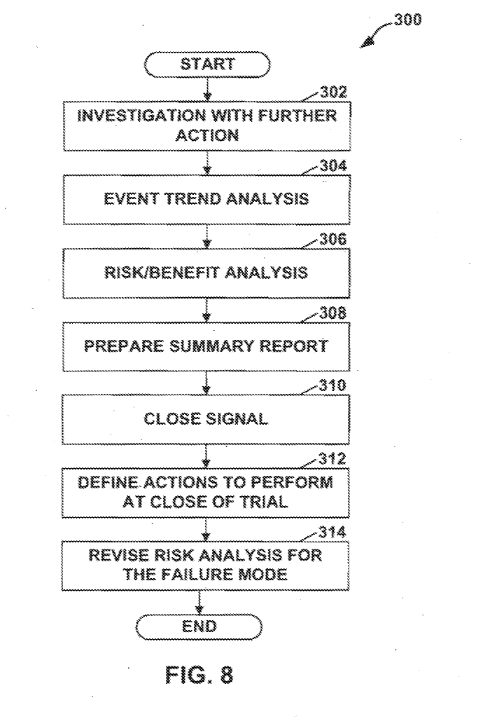

After performing the intervention procedure, the mitigation team may perform a closure procedure (158). When the mitigation team performs the closure procedure, the mitigation team may prepare information regarding the occurrence of the failure mode and how the mitigation team responded to the occurrence of the failure mode. FIG. 8, described in detail below, is a flowchart for an example closure procedure.

FIG. 6 is a flowchart for an example failure mode analysis procedure 200. A mitigation team may perform failure mode analysis procedure 200 in response to receiving an alert that indicates that a failure mode has occurred. In the example of FIG. 6, the mitigation team may open a signal in response to receiving the alert (202). The signal may be an entry for the occurrence of the risk in an issue tracking system. In some examples, the issue tracking system may be implemented at a computer system, such as computer system 10. Thus, when the mitigation team opens the signal, the mitigation team may generate an entry for the occurrence of the risk in the issue tracking system.

Next, the mitigation team may review information associated with the failure mode (204). For example, the mitigation team may review the mitigation procedure defined for the failure mode. In addition, the mitigation team may review aspects of the safety plan that relate to the failure mode, aspects of the monitoring plan that relate to the failure mode, aspects of the data management plan that relate to the failure mode, aspects of the quality and audit plan that relate to the failure mode, aspects of the statistical analysis plan that relate to the failure mode, and so on.

After reviewing the information associated with the failure mode, the mitigation team may develop an occurrence-specific action plan to mitigate the occurrence of the failure mode (206). The occurrence-specific action plan may indicate specific actions that the mitigation team will perform to mitigate the specific occurrence of the failure mode. For example, the occurrence-specific action plan may indicate that a given person will perform a site visit to a particular investigation site on a particular day.

The occurrence-specific action plan may differ from the mitigation procedure for the failure mode in that the occurrence-specific action plan may adapt the mitigation procedure for the failure mode to a particular occurrence of the failure mode. In contrast, the mitigation procedure for the failure mode may be general to all occurrences of the failure mode.

The mitigation team may develop the occurrence-specific action plan in light of the reviewed information associated with the failure mode. For instance, the mitigation team may develop the occurrence-specific action plan in light of the known data about the occurrence, aspects of the safety plan that relate to the failure mode, aspects of the monitoring plan that relate to the failure mode, aspects of the data management plan that relate to the failure mode, aspects of the quality and audit plan that relate to the failure mode, aspects of the statistical analysis plan that relate to the failure mode, and so on.

As part of developing the occurrence-specific action plan, the mitigation team may perform an internal review (208). During the functional internal review, the mitigation team may determine whether the failure mode has actually occurred. The mitigation team may collect additional information from one or more investigators and use this information to determine whether the failure mode has actually occurred. In other situations, the mitigation team may be able to use information already in the possession of the mitigation team to determine whether the failure mode has actually occurred. The mitigation team may develop different action plans depending on whether the failure mode actually occurred.

Furthermore, as part of developing the occurrence-specific action plan, the mitigation team may identify a type of the failure mode (210). For instance, the mitigation team may determine that the failure mode is a study subject safety failure mode, a protocol deviation failure mode, a recurring failure mode, a non-compliance failure mode, or another type of failure mode. The mitigation team may develop the occurrence-specific action plan based, at least in part, on the type of the failure mode. A protocol deviation may be a variation from processes or procedures defined in a protocol. Deviations usually do not preclude the overall evaluability of subject data for either efficacy or safety, and may be acknowledged and accepted in advance by the sponsor. Good clinical practices (GCP) recommend that deviations be summarized by site and by category as part of the report of study results so that the possible importance of the deviations to the findings of the study can be assessed.

FIG. 7 is a flowchart for example intervention procedure 250. After the mitigation team develops an occurrence-specific action plan, the mitigation team may perform the occurrence-specific action plan (252). When the mitigation team performs the occurrence-specific action plan, the mitigation team may intervene with one or more of the investigators to mitigate the failure mode.

As a result of performing the occurrence-specific action plan, the mitigation team may determine whether to escalate the occurrence of the failure mode (254). Escalation of the occurrence may entail requesting the involvement of one or more groups outside the mitigation team. For example, if the mitigation team includes monitors 16, monitors 16 may escalate the occurrence by requesting the involvement of one or more groups at sponsor 12. Such groups may include safety assurance groups, data management groups, and so on.

The mitigation team may make the determination to escalate the occurrence based on various conditions indicated in the occurrence-specific action plan. For example, the mitigation team may escalate the occurrence in response to determining that the occurrence is more severe than initially thought. In this example, the occurrence-specific action plan may indicate a degree of severity necessary to determine that the occurrence should be escalated.

After making the determination to escalate the occurrence (“YES” of 254), the mitigation team or another team may perform an escalated response (256). For example, the mitigation team or another team may devote additional resources to mitigating the occurrence of the failure mode.

FIG. 8 is a flowchart that illustrates an example closure procedure 300. A mitigation team may perform closure procedure 300 after performing an intervention procedure, such as the example intervention procedure illustrated in FIG. 7.

After the mitigation team starts signal closure operation 300, the mitigation team may perform further investigation regarding the occurrence (302). For example, the failure mode may occur at a particular investigation site. In this example, the mitigation team may perform further investigation to determine whether similar occurrences of the failure mode are occurring at other investigation sites.

In addition, the mitigation team may perform an event trend analysis (304). When the mitigation team performs the event trend analysis, the mitigation team may determine that an intervention is warranted to mitigate risk. For example, an event trend analysis may identify conditions of non-compliance at one or more sites that may indicate the need for re-training the investigator and/or study staff to ensure compliance.

The mitigation team may also perform a risk/benefit analysis (306). In the risk/benefit analysis, the mitigation team may determine whether the benefits of continuing the trial outweigh the risks associated with continuing the trial, given the occurrence of the failure mode.

In addition, the mitigation team may prepare a summary report (308). The summary report may detail the occurrence of the failure mode, how the mitigation team responded to the occurrence of the failure mode, results of the additional investigation, results of the event trend analysis, results of the risk/benefit determination, and/or other information.

After preparing the summary report, the mitigation team may close the signal for the occurrence of the failure mode (310). When the mitigation team closes the signal, the mitigation team may indicate in an issue tracking system that the occurrence has been fully responded to.

Furthermore, in some examples, the mitigation team may define actions to perform at the close of the trial (312). For example, the mitigation team may indicate that, at the close of the trial, a full report on the occurrence is to be prepared. In another example, the mitigation team may indicate that, at the close of the trial, monitoring plans, data management plans, safety plans, detection procedures, mitigation procedures, and/or other plans or procedures are to be modified in light of the occurrence of the failure mode. For example, a trend analysis may reveal inconsistencies that warrant escalation and dedication of additional resources to resolve the discrepancy.

In some examples, the mitigation team may also revise the risk analysis for the failure mode (314). For example, the mitigation team may revise a severity score, an occurrence score, a priority category, a detection score, a detection procedure, a mitigation procedure, or other information in the risk analysis for the failure mode.

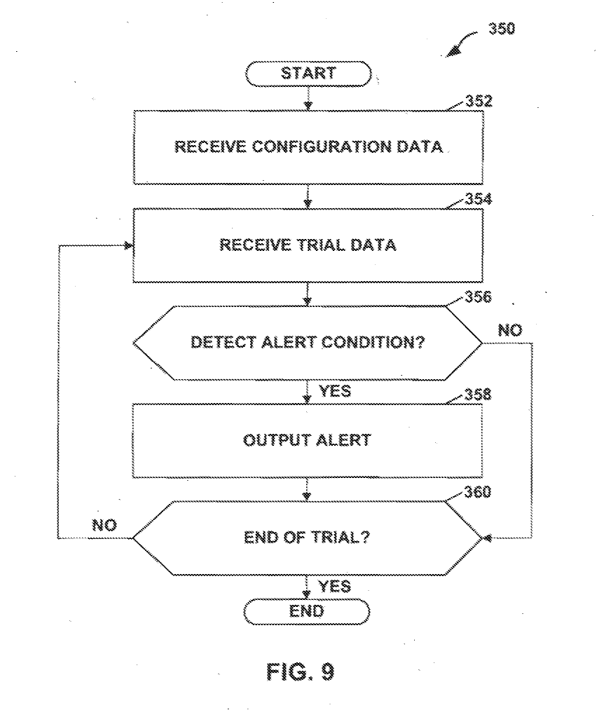

FIG. 9 is a flowchart that illustrates an example operation 350 performed by a computer system. In some examples, computing system 10 of FIG. 1 may perform operation 350.

In the example of FIG. 9, the computer system receives configuration data before a start of a trial of a medical therapy (352). The configuration data may configure the computer system to detect alert conditions indicative of occurrences of risks associated with the trial. The computer system may receive the configuration data from various sources. For example, the computer system may receive the configuration data via a communication network from one or more computers used by the sponsor. In another example, the configuration data may be generated by one or more entities, such as the sponsor, and stored on one or more physical computer-readable storage media. In this example, the computer system may read the configuration data from the physical computer-readable storage media. In another example, the computer system may receive user input to configure the computer system to detect the alert conditions.

The configuration data may configure the computer system in various ways. For example, the configuration data may comprise a set of rules. Each of the rules may specify a condition and an action to be performed when the condition is satisfied. In some instances, the configuration data may include instructions that indicate to the computer system how to determine whether the conditions of the rules are satisfied. For example, the instructions may indicate to the computer system how to identify particular trends within the trial data.

Furthermore, the configuration data may include one or more computer programs or scripts. Such computer program or scripts may include software instructions that, when executed, configure the computer system to detect the alert conditions associated with various failure modes and may configure the computer system to output alerts associated with the failure modes.

Subsequently, after the trial begins, the computer system may receive trial data generated during conduct of the trial (354). In some examples, the trial data may be generated by one or more investigators as part of the investigators conducting the trial on behalf of a sponsor of the trial. The computer system may receive the trial data in various ways. For example, the computer system may receive the trial data through a system of web-based forms displayed by web browser applications executed on computers used by the investigators. In another example, the computer system may receive the trial data through special-purpose applications. In some examples, the computer system may receive electronic case report forms that contain the trial data.

When the computer system receives the trial data, the computer system may store the trial data in a database. The phrase “data based” may refer to the act of putting data into a database or computer platform system. In this disclosure, the term “dataset” may refer to a collection of structured data in a single file.

Furthermore, after the trial begins, the computer system may determine, based on the trial data, whether any of the alert conditions have occurred (356). For example, the trial data may originate from multiple investigation sites. In this example, the computer system may detect that a particular alert condition has occurred when the trial data originating from one of the investigation sites is inconsistent with the trial data originating from other ones of the investigation sites.

In some examples, the computer system may determine, on a real-time basis, whether the alert conditions have occurred. For instance, the computer system may determine whether the alert conditions have occurred in response to receiving the trial data. In other examples, the computer system may determine in batch mode whether the alert conditions have occurred.

The computer system may determine in various ways whether any of the alert conditions have occurred. For example, each of the alert conditions may be expressed as one or more condition-action rules. In this example, the computer system may determine that an alert condition has occurred when the conditions of the rules are satisfied.

In response to detecting that an alert condition has occurred (“YES” of 356), the computer system may output an alert associated with the alert condition (358). The alert may be associated with a pre-defined mitigation procedure. In some examples, the alert may indicate the mitigation procedure. For instance, in such examples, the alert may indicate that the mitigation procedure instructs a monitoring organization to conduct a site visit. In other examples, the alert may include information, such as a failure mode identifier, that enables a mitigation team to determine the pre-defined mitigation procedure.

The computer system may output the alert in various ways. For example, the computer system may output the alert by sending an email, fax, instant message, text message, or other type of written alert to a monitor and/or a team associated with the sponsor. In another example, the computer system may output the alert by including or enabling the alert to be included in a webpage. In another example, the computer system may display the alert along with (e.g., next to) a questionable element of the trial data.

The computer system may output the alert to various groups, depending on the mitigation plan defined for the failure mode associated with the alert condition. For example, if the mitigation procedure is to be performed at least in part by a monitoring organization that monitors the conduct of the trial, the computer system may output the alert to the monitoring organization. In this example, the mitigation procedure may require a site visit to be conducted. In another example, if the mitigation procedure is to be performed at least in part by the sponsor, the computer system may output the alert to the sponsor.

In another example, the failure mode may relate to a low severity issue, such as a data consistency issue. Data consistency issues may include data entry issues where a researcher inputs clearly erroneous data. In this example, the mitigation procedure may be performed at least in part by a given investigator. Hence, this example, the computer system may output the alert to the given investigator. The alert may include a prompt (e.g., to the given investigator) to resolve the data consistency issue.

In other examples, the computer system may output an indication of the mitigation procedure separately from the alert. For example, the computer system may output an indication of the mitigation procedure in response to a request or command received by the computer system. In this example, the computer system may receive such a request or command in various ways. For instance, the computer system may receive such a request or command via a web-based interface, a command-line interface, or another type of interface. The indication of the mitigation procedure may include text that describes some or all aspects of the mitigation procedure. In other examples, the indication of the mitigation procedure may include data that identifies printed material describing some or all aspects of the mitigation procedure.

After outputting the alert in step 358 or after determining that no alert condition has occurred (“NO” of 356), the computer system may determine whether the trial has ended (360). If the trial has not yet ended, the computer system may receive additional trial data (354) and steps 356, 358, and 360 may recur.

FIG. 10 is a conceptual diagram that illustrates an example table 450 for identifying failure modes. A sponsor of a trial of a medical therapy (e.g., sponsor 12) may use table 450 to identify failure modes associated with the trial prior to the start of the trial. In the example of FIG. 10, table 450 has seventeen columns: a function column 452, a potential failure mode column 454, a potential effects of failure column 456, an initial severity score column 458, a classification column 460, a potential cause of failure column 462, an initial occurrence score column 464, a current controls to prevent failure column 466, a current controls to detect failure column 468, an initial detection score column 470, an initial risk priority number (RPN) column 472, a risk mitigation column 474, a responsible party column 476, a revised severity column 478, a revised occurrence score column 480, a revised detection score column 482, and a revised RPN column 484.

Table 450 has a plurality of rows 486A-486N (collectively, “rows 486”). Each of rows 486 may correspond to a different failure mode identified by the sponsor.

When the sponsor identifies a failure mode, the sponsor may insert in function column 452 a description of study function impacted by the failure mode. For instance, if the failure mode impacts subject safety, the sponsor may insert the label “safety” in the appropriate cell of function column 452. If the failure mode impacts data integrity, the sponsor may insert the label “data management” in the appropriate cell of function column 452.

Furthermore, the sponsor may insert a description of the failure mode in column 454. For example, if the failure mode relates to an incorrect classification of an event, the sponsor may describe this incorrect classification of the event in the appropriate cell of function column 452.

The sponsor may insert a severity score for the failure mode in an appropriate cell of severity column 458. Failure modes with higher severity scores are anticipated to have more severe effects than failure modes with lower severity scores. In the example of FIG. 10, severity scores may be on a scale from 1-5.

For instance, the sponsor may assign a severity score of “1” to a failure mode if the occurrence of the failure mode is likely to have limited impact on the trial, there are no safety issues associated the failure mode, and there are no impacts on operations of the trial. Typically, failure modes assigned a severity score of “1” can be resolved through communication with investigation sites and routine monitoring visits to verify that the investigation sites made the appropriate corrections. Failure modes assigned a severity score of “1” may have minimal, if any, financial impacts. In some examples, financial impacts include changes to financial situations of the sponsor or other entity.

The sponsor may assign a severity score of “2” to a failure mode if the occurrence of the failure mode is likely to have some effects on the trial, but such effects can be mitigated by performing a mitigation procedure. Typically, failure modes assigned a severity score of “2” have minimal, if any, financial impacts. In some examples, the effects of a failure mode can be mitigated if the effects of the failure mode can be reduced or eliminated.

The sponsor may assign a severity score of “3” to a failure mode if the occurrence of the failure mode is likely to have effects on the trial that can be mitigated through mitigation procedures. However, occurrence of such a failure mode may require escalation from a monitor to the sponsor or other group. Typically, failure modes assigned severity scores of “3” have financial, operational, and/or regulatory impacts that cannot be corrected without intervention in the trial.

The sponsor may assign a severity score of “4” to a failure mode if the occurrence of the failure mode is likely to have severe impacts on trial conduct and/or subject safety if unresolved. It may not be possible to resolve the occurrence of such failure modes through short term action. Furthermore, the sponsor may assign a severity score of “4” to a failure mode if mitigation of the failure mode requires an on-site visit, audit of an investigation site, investigation site retraining, investigation site closure, and/or escalation of the occurrence to quality, safety, and/or other teams. Typically, failure modes assigned severity scores of “4” have significant impacts on trial budgets. Mitigation of failure modes assigned severity scores of “4” may require additional resources and travel costs.

The sponsor may assign a severity score of “5” to a failure mode if the occurrence of the failure mode is likely to actually disrupt conduct of the trial or affect subject safety. The occurrence of such a failure mode may require immediate escalation and team response. Typically, failure modes assigned severity scores of “5” may have significant financial impacts on the trial. Such failure modes may lead to audit, corrective and preventive action (CAPA), or investigation site closure, may result in the inability to use trial data generated by an investigation site, and/or may have regulatory implications.

In addition, the sponsor may assign a classification score to the failure mode and insert the classification score into an appropriate cell of classification column 460. As described above, the sponsor may assign higher classification scores to failure modes that are likely to require more intensive intervention to remediate the failure modes. The classification scores may also be referred to as priority scores.

The sponsor may also identify one or more potential causes of the failure mode. The sponsor may then insert descriptions of the identified potential causes of the failure mode in an appropriate cell of column 462. For example, the sponsor may indicate in an appropriate cell of column 462 that training of staff is a potential cause of the failure mode.

In addition, the sponsor may assign an occurrence score to the failure mode and insert the occurrence score into an appropriate cell of occurrence score column 464. The sponsor may assign higher occurrence scores to failure modes with higher probabilities of occurring. Occurrence scores may be on a scale from 1-5.

The sponsor may also determine controls to prevent the occurrence of the failure mode. The sponsor may then insert a description of such controls in an appropriate cell of column 466. For example, the sponsor may indicate in column 466 that pre-study staff training is a technique for preventing the occurrence of the failure mode.

In addition, the sponsor may determine controls to detect the occurrence of the failure mode. The sponsor may then insert a description of such controls in an appropriate cell of column 468. For example, the sponsor may indicate in column 468 that a data monitoring committee may be used to detect the occurrence of the failure mode.

The sponsor may also assign a detection score to the failure mode and insert the detection score into an appropriate cell of detection score column 470. The sponsor may assign higher detection scores to failure modes that are more difficult to detect than to failure modes that are relatively less difficult to detect. In the example of FIG. 10, the detection score may be on a scale from 1 to 5.

In addition, the sponsor may assign a RPN to the failure mode and insert the RPN into an appropriate cell of initial RPN column 472. The RPN of the failure mode may be equal to the value that results from multiplying the initial severity, occurrence, and detection scores of the failure mode.

Furthermore, before the start of the trial, the sponsor may identify a mitigation procedure for the failure mode. The sponsor may then insert a description of the mitigation procedure into an appropriate cell of column 474.

Before the start of the trial, the sponsor may also identify a party responsible for performing the mitigation procedure. For example, the sponsor may identify a safety leader or data management team as the party responsible for performing the mitigation procedure. The sponsor may then identify the responsible party in responsible party column 476.

During the course of the trial, the sponsor may revise the severity score, occurrence score, detection score, and RPN for the failure mode one or more times. The sponsor may insert these scores in appropriate cells of columns 478, 480, 482, and 484. For example, when the trial starts, certain types of failure modes are more likely to occur due to inexperience of the investigators. Consequently, occurrence scores for these risks may initially be relatively high. However, during the course of the trial, the occurrence scores for these risks may decrease as the investigators acquire more experience.

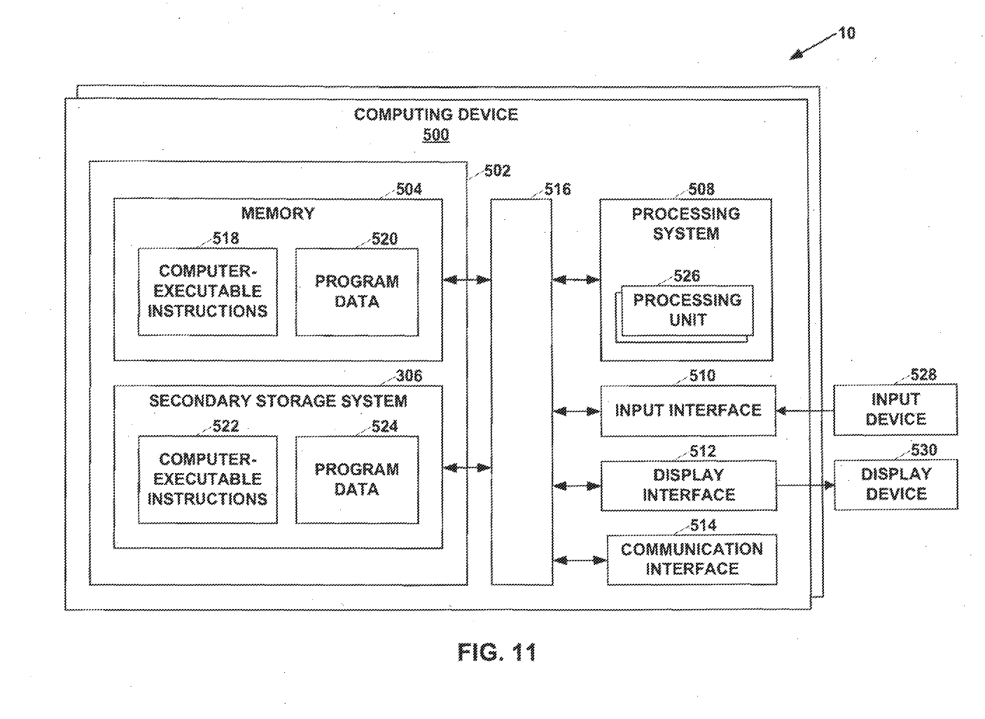

FIG. 11 is a block diagram of an example configuration of computer system 10. In the example of FIG. 11i, computer system 10 comprises a computing device 500 and one or more other computing devices.

Computing device 500 is a physical device that processes information. In the example of FIG. 11, computing device 500 comprises a data storage system 502, a memory 504, a secondary storage system 506, a processing system 508, an input interface 510, a display interface 512, a communication interface 514, and one or more communication media 516. Communication media 516 enable data communication between processing system 508, input interface 510, display interface 512, communication interface 514, memory 504, and secondary storage system 506. Computing device 500 can include components in addition to those shown in the example of FIG. 11. Furthermore, some computing devices do not include all of the components shown in the example of FIG. 11.

A computer-readable medium may be a medium from which a processing system can read data. Computer-readable media may include computer storage media and communications media. Computer storage media may include physical devices that store data for subsequent retrieval. Computer storage media are not transitory. For instance, computer storage media do not exclusively comprise propagated signals. Computer storage media may include volatile storage media and non-volatile storage media. Example types of computer storage media may include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media may include media over which one device can communicate data to another device. Example types of communication media may include communication networks, communications cables, wireless communication links, communication buses, and other media over which one device is able to communicate data to another device.

Data storage system 502 may be a system that stores data for subsequent retrieval. In the example of FIG. 11, data storage system 502 comprises memory 504 and secondary storage system 506. Memory 504 and secondary storage system 506 may store data for later retrieval. In the example of FIG. 11, memory 504 stores computer-executable instructions 518 and program data 520. Secondary storage system 506 stores computer-executable instructions 522 and program data 524. Physically, memory 504 and secondary storage system 506 may each comprise one or more computer storage media.

Processing system 508 is coupled to data storage system 502. Processing system 508 may read computer-executable instructions from data storage system 502 and executes the computer-executable instructions. Execution of the computer-executable instructions by processing system 508 may configure and/or cause computing device 500 to perform the actions indicated by the computer-executable instructions. For example, execution of the computer-executable instructions by processing system 508 can configure and/or cause computing device 500 to provide Basic Input/Output Systems, operating systems, system programs, application programs, or can configure and/or cause computing device 500 to provide other functionality.

Processing system 508 may read the computer-executable instructions from one or more computer-readable media. For example, processing system 508 may read and execute computer-executable instructions 518 and 522 stored on memory 504 and secondary storage system 506.

Processing system 508 may comprise one or more processing units 526. Processing units 526 may comprise physical devices that execute computer-executable instructions. Processing units 526 may comprise various types of physical devices that execute computer-executable instructions. For example, one or more of processing units 526 may comprise a microprocessor, a processing core within a microprocessor, a digital signal processor, a graphics processing unit, or another type of physical device that executes computer-executable instructions.

Input interface 510 may enable computing device 500 to receive input from an input device 528. Input device 528 may comprise a device that receives input from a user. Input device 528 may comprise various types of devices that receive input from users. For example, input device 528 may comprise a keyboard, a touch screen, a mouse, a microphone, a keypad, a joystick, a brain-computer interface device, or another type of device that receives input from a user. In some examples, input device 528 is integrated into a housing of computing device 500. In other examples, input device 528 is outside a housing of computing device 500. In some examples, input device 528 may receive configuration data, trial data, and/or other types of data as described above.

Display interface 512 may enable computing device 500 to display output on a display device 530. Display device 530 may be a device that displays output. Example types of display devices include monitors, touch screens, display screens, televisions, and other types of devices that display output. In some examples, display device 530 is integrated into a housing of computing device 500. In other examples, display device 530 is outside a housing of computing device 500. In some examples, display device 530 may display alerts or other types of data as described above.

Communication interface 514 may enable computing device 500 to send and receive data over one or more communication media. Communication interface 514 may comprise various types of devices. For example, communication interface 514 may comprise a Network Interface Card (NIC), a wireless network adapter, a Universal Serial Bus (USB) port, or another type of device that enables computing device 500 to send and receive data over one or more communication media. In some examples, communication interface 514 may receive configuration data, trial data, and/or other types of data as described above. Furthermore, in some examples, communication interface 514 may output alerts, queries, and/or other types of data as described above.

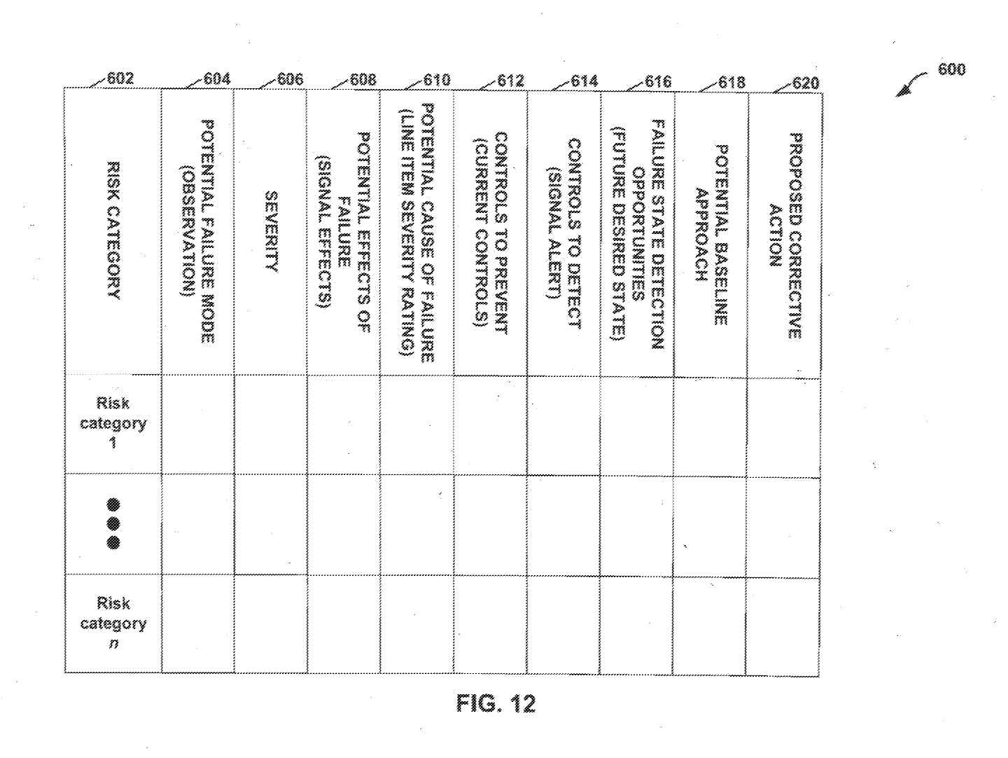

FIG. 12 is a conceptual diagram that illustrates a first example table 600 for risk designation. The sponsor may enter information into table 600 when categorizing failure modes prior to the start of a trial. The sponsor may generate table 600 at the start of a trial to identify potential signal alerts which may be embedded in the database, triggered when acceptable quality levels (AQL) is out of scope and would require action to resolve.

Each row in table 600 may correspond to a different failure mode category. Table 600 includes a risk category column 602, a potential failure mode column 604, a severity column 606, a potential effects of failure column 608, a potential cause of failure column 610, a current controls to prevent column 612, a current controls to detect column 614, a future state detection opportunities column 616, a potential baseline approach column 618, and a proposed corrective action column 620. Cells in column 602 specify a risk category of a failure mode. Cells in column 604 specify potential failure modes. Cells in column 606 specify severities of failure modes. Cells in column 608 specify potential effects of failure modes. Cells in column 610 specify potential causes of failures for failure modes. Cells in column 612 specify current controls to prevent occurrences of failure modes. Cells in column 614 specify current controls to detect occurrences of failure modes. Cells in column 616 specify potential opportunities to detect occurrences of failure modes in the future. Cells in column 618 specify a potential baseline approach for a failure mode. Cells in column 620 specify proposed corrective actions for failure modes.

For example, in a 1^{st} row of table 600, the sponsor may enter “trial related risk” in column 602. The sponsor may enter “rate of recruitment/enrollment (Severity: 3)” in column 604. The sponsor may enter “4” in column 606. The sponsor may enter “inappropriate enrollments, lost enrollments, patient care compromised” in column 608. In column 610, the sponsor may enter:
1) Patients did not meet study inclusion/exclusion criteria.
2) Physician not clear on inclusion/exclusion criteria.
3) Inadequate or missing subject screening and enrollment log (Sev-3).
4) Inadequate or inappropriate subject identification (Sev-4)”.
   In column 612, the sponsor may enter:
1) Monitoring visit.
2) Data review.
   In column 614, the sponsor may enter:
1) Trending of monitoring actions.
2) Study report: % of subjects meeting inclusion/exclusion criteria.
3) Data queries focused on inclusion/exclusion compliance.
   In column 616, the sponsor may enter:
1) Establish upper limit for site based on potential for enrollment at site.
2) Study reports reflecting metrics on inclusion/exclusion with limits defined.
   In column 618, the sponsor may enter:
1) Capture expected enrollment rate/month for study.
2) Establish expected enrollment potential per site (based on patient volume).
3) Establish metrics to show from first enrollment to current date how site performs to defined limits.
   In column 620, the sponsor may enter:
1) Site visit to retrain personnel on inclusion/exclusion criteria.
2) Shut down site.

Furthermore, in a 2^{nd} row of table 600, the sponsor may enter “site personnel” in column 602. The sponsor may enter “identification of inadequate competencies or performance of site personnel” in column 604. The sponsor may enter “4” in column 606. In column 608, the sponsor may enter “study execution expectations not met, site non-conformance (483), patient care compromised.” in column 610, the sponsor may enter:
1) Personnel turnover (e.g. Lost Primary Physician) (Sev-3).
2) Study no longer has a coordinator.
3) Frequent changes in coordinator.
4) Experience of site personnel (e.g. physician, coordinator) (Sev-2).
5) Failure of investigator to meet with study monitor (Sev-2).
6) Inappropriate Delegation of Authority (Sev-4).
7) Failure to maintain case histories (Sev-4).
8) Failure to follow written Sponsor standard operating procedures (Sev-4).
9) Missing or inadequate credentials of research staff (specific to testing done—who is required) (Sev-4).
10) Lack of site responsiveness (e.g. follow-up with monitors, study teams) (Sev-2).
11) Inadequate investigator involvement/oversight (Sev-3).
   In column 612, the sponsor may enter:
1) Site Qualification Process.
2) Review CV's.
3) Knowledge base of previous performance.
   In column 614, the sponsor may enter:
1) Study team notified of personnel changes.
2) Monitoring/field notify study team of personnel changes.
3) Field resources share knowledge of gaps in competencies study team.
4) Unanswered e-mails, phone calls (if collected).
   In column 616, the sponsor may enter:
1) Automate within EDC system (manage at sign-on time) a delegated task list review, on some regular basis (e.g. enrollments, monthly) for the site to verify correct and matches current site personnel, generate query if changes have occurred.
2) Trend site turnover rate, set signal based on limits with personnel type/frequency.
   In column 618, the sponsor may enter:
1) Capture current delegated task list.
2) Begin capturing site turn over (may be manual for now).
   In column 620, the sponsor may enter:
1) Based on effects of turnover, add monitoring visit during and/or after on-boarding of personnel.

Furthermore, in a 3^{rd} row of table 600, the sponsor may enter “critical study element risk” in column 602. The sponsor may enter “protocol non-compliance (failure to comply with protocol (Sev-4)” in column 604. The sponsor may enter “4” in column 606. In column 608, the sponsor may enter “Lost patient enrollment for study, site non-compliance (483).” In column 610, the sponsor may enter:
1) Ineffective protocol training.
2) Site personnel turn over.
3) Protocol inconsistencies (Sev-4).
4) Patient visits, randomization issues, blinding issues (Sev-4).
5) Complexity of protocol (Sev-3).
6) Failure to follow investigational plan (Sev-5).
7) Repetitive protocol non-compliance (Sev-4).
   In column 612, the sponsor may enter:
1) Monitoring visit.
2) Data review.
   In column 614, the sponsor may enter.
1) Monitoring action items (Section 3—Monitoring Action Item Code List).
2) % of deviations/patient enrolled, trending of deviation types, etc.
   In column 616, the sponsor may enter:
1) Establish deviation trigger criteria with lower/upper bounds.
2) Automate trigger notification to event management process.
   In column 618, the sponsor may enter:
1) Capture current deviation % and type per site (may be manual for now).
   In column 620, the sponsor may enter:
1) Audit site.
2) Retrain on protocol.
3) Schedule monitoring visit after predetermined number of enrollments have occurred.

Furthermore, in a 4^{th} row of table 600, the sponsor may enter “documentation” in column 602. The sponsor may enter “identification of problem with record keeping (e.g., a site organizational management of documentation (Sev-3)” in column 604. The sponsor may enter “4” in column 606. In column 608, the sponsor may enter “inadequate investigator involvement/oversight, site non-compliance (483).” In column 610, the sponsor may enter:
1) Maintaining site regulatory binder filings (Sev-1).
2) Missing signed agreements (e.g. investigator, financial disclosure, trial agreement, Form FDA 1572) (Sev-1 or 2).
3) Missing or inconsistent signatures/handwriting (e.g. site signature log) (Sev-2).
4) Discrepancy between sponsor/CRO/site records (Sev-1).
5) Missing protocol, amendments or administrative documents (Sev-3).
6) Inadequate or missing delegation of authority documents (sponsor) (Sev-4).
7) Delegation of services provided (Core Lab, CRO, etc.).
8) Delegation Task List (inadequate/missing) at site, should contain initials and signatures (verify consistent practice) (Sev-5).
9) Inadequate or missing documentation of protocol exemptions, deviations and/or violation (Sev-5).
10) Inadequate or missing documentation for site personnel training (Sev-3).
11) Identification of problem with record keeping (e.g. site organizational management of documentation).
12) Missing updated CV's of study personnel (Sev-2).
13) Inadequate or missing subject identification log (Sev-3).
14) Missing documentation for site personnel training (Sev-3).
   In column 612, the sponsor may enter:
1) Monitoring visit.
   In column 614, the sponsor may enter:
1) Monitoring action items (Section 8—Monitoring Action Item Code List).
2) Review of internal documentation received from site (e.g. verify protocol versions of training).
   In column 616, the sponsor may enter:
1) Trending of actions at site or across sites (comparison across sites).
2) Repetitive occurrence of issues at site (e.g., monitoring actions reoccurring if follow-up visits).
3) Long term strategy (create site specific websites to contain appropriate regulatory documents and leverage central monitoring to review).
   In column 618, the sponsor may enter:
1) Trend monitoring existing monitoring actions.
2) On upcoming monitoring trip—prepare information from documents received from site and compare to site information.
3) Store baseline metrics.
   In column 620, the sponsor may enter:
1) Ensure timely and closing of monitoring actions, if severe compliance issues: schedule a follow-up monitoring vest to occur under pre-defined criteria (e.g. IRB renewal timing, new protocol version).

Furthermore, in a 5^{th} row of table 600, the sponsor may enter “study execution (customer)” in column 602. The sponsor may enter “Identification of process or data quality issues (e.g. incomplete data, follow-up compliance, missing patient diaries, CRF entry, completion of data)” in column 604. The sponsor may enter “4” in column 606. In column 608, the sponsor may enter “inability to leverage data in study outcomes, inability to leverage outcomes of site.” In column 610, the sponsor may enter:
1) Delayed entry of information in Case Book (CRF).
2) Delay in query resolution (Sev-4).
3) Patient diaries not submitted to sponsor.
4) Device data not transmitted to sponsor.
5) Follow-up windows not managed at sites.
6) Paper CRFs not sent to sponsor in a timely fashion.
7) High relative to other sites (deviation reporting) (Sev-3)
8) Lack of historical site performance (Sev-3)
9) Prior history of FDA 483 (Sev-2)
10) Inadequate or missing patient compensation (Sev-3)
   In column 612, the sponsor may enter:
1) Monitoring Visit
2) Data Review
3) Site Qualification Process
   In column 614, the sponsor may enter:
1) Automation of Data Queries
2) Monitoring action items (Section 2—Monitoring Action Item Code List)
   In column 616, the sponsor may enter:
1) Increase edit checks to look for signals of concern (e.g. trend for site of time of entry vs. patient visit date)
2) Determine critical CRF deficiencies to be watched, define acceptable ranges of performance, design triggers that feed our event process.
   In column 618, the sponsor may enter:
1) Capture query closure cycle times
2) Capture types of queries and percentage of total
3) Capture cycle time for delay in data entry, define range of acceptance, % outside of range.
   In column 620, the sponsor may enter:
1) Look at baseline data—if unacceptable performance, schedule discussion with sight (e.g., training, need for monitoring trip, need for audit)

Furthermore, in a 6^{th} row of table 600, the sponsor may enter “study execution (sponsor)” in column 602. The sponsor may enter “identification of inefficiencies in internal processes and/or study execution (e.g., data management plan, data quality plan, monitoring plan, statistics plan, study metrics (Sev-3)” in column 604. The sponsor may enter “3” in column 606. In column 608, the sponsor may enter:
Internal Audit Findings
Inadequate performance in functional groups
Regulatory Audit—483 Outcomes
Duration of study extended
   In column 610, the sponsor may enter:
1) Inefficient oversight to execution of plans (e.g., falling below expected monitoring %, data management missing data review steps)
2) Actions are not created when study metrics reflect execution concerns
3) Information from biostatistician on inaccuracies or repetitive data read (e.g., analysis different that SAP) (Sev-TBD)
   In column 612, the sponsor may enter:
1) Oversight by managers.
2) Study team meetings (action plans).
3) Study assessments (e.g. periodic assessment by independent group).
4) Some frequency of study metrics review and action planning.
   In column 614, the sponsor may enter:
1) Study team metrics (e.g. data queries, monitoring plan %, enrollment.
2) Cross functional reviews of internal plans and templates (required review by SOP).
3) Committee review of study outcomes compared to SAP/Endpoints.
   In column 616, the sponsor may enter:
1) Institute data quality meetings (e.g. review critical data w/ action plans).
2) On high risk studies, plan assessments in appropriate phases of the study.
   In column 618, the sponsor may enter:
1) Capture any metrics and trends that have been in place for study
   In column 620, the sponsor may enter:
1) Look at baseline metrics, if concerns exist—create an action plan to address those concerns.
2) If audit/assessment data exists for study, check completeness of audit finding and verify continued effectiveness.

Furthermore, in a 7^{th} row of table 600, the sponsor may enter “facility risk” in column 602. The sponsor may enter “identification of inadequate or missing facility storage or SOPs” in column 604. The sponsor may enter “4” in column 606. In column 608, the sponsor may enter:
Lost product.
Inappropriate usage of Clinical Product.
Non-compliant site (separation from study).
   In column 610, the sponsor may enter:
1) Existence of written site standard operation procedures (SOPs)/good clinical practice (GCP) compliance (Sev-1).
2) Inadequate of missing facilities protocol procedures (Sev-4).
3) Unsecured investigational product storage area space (Sev-4).
4) Inadequate device accountability (Sev-4).
   In column 612, the sponsor may enter:
1) Site Qualification Process.
2) Clinical Product utilized on non-study patient.
3) Missing product during inventory cycle counting activity.
4) Monitoring action items (Section 6—Monitoring Action Item Code List).
   In column 614, the sponsor may enter;
1) US Device Registration System (DRS)—clinical device serial/lot number shows up as implanted in a non-clinical patient.
   In column 616, the sponsor may enter
1) Standard site qualification questions related to facility abilities to run clinical studies.
   In column 618, the sponsor may enter:
1) Review site qualification questions to ensure information was collected related to the causes of facility issues.
   In column 620, the sponsor may enter:
1) If critical questions are missing from Site Qualification Form, potentially schedule an audit or monitoring trip to confirm facility capabilities.

Furthermore, in an 8^{th} row of table 600, the sponsor may enter “patient safety” in column 602. The sponsor may enter “identification of inadequate process or regulatory reporting in relationship to adverse events, unanticipated adverse devices effects, etc.” in column 604. The sponsor may enter “5” in column 606. In column 608, the sponsor may enter:
Non-compliant site participating on study.
Potential patient safety issues.
   In column 610, the sponsor may enter:
1) Unreported adverse events (Sev-4/5).
2) Timeliness of reporting (outside regulation expectations) (Sev-4).
3) Not completing adverse event form in Case Book (EDC).
   In column 612, the sponsor may enter:
1) Utilization of adverse event (AE) forms in CRF.
2) Data management plans.
3) Safety plans.
   In column 614, the sponsor may enter:
1) Data review process to assess all open text fields for potential safety related comments (query fired and/or safety contacted).
2) AE reports generated from AE forms on CRF:
3) Monitoring action items (Section 4—Monitoring Action Item Code List)
   In column 616, the sponsor may enter:
1) Trending of AE's within site—CRF (establish acceptable occurrence in relationship to number of subjects enrolled)—including delay in entry of actual event (if possible).
2) Trending of monitoring actions related to safety.
3) Previous performance of site in relationship to managing safety events.
   In column 618, the sponsor may enter;
1) Capture all safety related monitoring actions for study (breakdown by site).
2) Capture all AE Form information (event date vs. entry date).
   In column 620, the sponsor may enter:
1) If critical baseline data reflects concerns at a site or across study, schedule monitoring visits or audits (will depend on severity of concern).

Furthermore, in a 9^{th} row of table 600, the sponsor may enter “IRB/EC process” in column 602. The sponsor may enter “identification of inadequate process or reporting with IRB/MEC utilized by site/study” in column 604. The sponsor may enter “5” in column 606. In column 608, the sponsor may enter:
IRB suspended.
Site separation.
Lost enrollment.
Risk to study outcomes.
   In column 610, the sponsor may enter:
1) Failure to obtain IRB/IEC approvals (Sev-5).
2) Failure to submit progress/annual/final reports to IRB/MEC (Sev-3).
3) Inadequate or missing relevant IRB/IEC communication and submission documents (Sev-2).
4) Missing IRB/IEC member roster (Sev-2).
5) Failure to follow conditions of approval imposed by IRB/IEC (Sev-4).
6) IRB suspension (Sev-5).
7) Missing IRB/IEC approved subject consent/assent form (Sev-4).
   In column 612, the sponsor may enter:
1) Monitoring visit.
2) Internal SOP for site activation.
   In column 614, the sponsor may enter:
1) Monitoring action items (Section 7—Monitoring Action Item Code List).
2) Site activation checklist (contains red IRB/MEC letter of approval, etc.).
   In column 618, the sponsor may enter:
1) Trend existing monitoring actions (study/site).
2) Assign risk criteria to category of actions.
3) Verify site activation checklist aligns with documents currently in study files.
   In column 620, the sponsor may enter:
1) If risk is high, schedule monitoring visit of audit for site.

Furthermore, in a 10^{th} row of table 600, the sponsor may enter “patient consent/confidentiality process” in column 602. The sponsor may enter “inadequate process or patient engagement in relationship to patient consent forms” in column 604. The sponsor may enter “5” in column 606. In column 608, the sponsor may enter:
Lost enrollment.
Site separation.
Risk to study outcomes.
   In column 610, the sponsor may enter:
1) Informed consent issues (e.g. timing, signature, missing) (Sev-5).
2) Inadequate subject consent/assent form (Sev-4).
3) Inadequate consenting process (Sev-4).
4) Missing or illegible signatures, dates, and/or times on subject consent form (Sev-4).
5) Inadequate or missing documentation of re-consenting process (Sev-4),
6) Subject/patient confidentiality compromised (Sev-4).
   In column 612, the sponsor may enter:
1) Monitoring visit.
   In column 614, the sponsor may enter:
1) Monitoring action items (Section 5—Monitoring Action Item Code List).
   In column 616, the sponsor may enter:
1) Implement computerized consent form, ensures knowledge of timing of consent compared to IRB approval (could stop enrollment).
   In column 618, the sponsor may enter:
1) Trend existing monitoring actions (study/site).
2) Assess frequency of occurrence at site.
   In column 620, the sponsor may enter:
1) If multiple occurrences, same actions and multiple patients—determine future risk at site and plan monitoring trips accordingly.

Furthermore, in an 11^{th} row of table 600, the sponsor may enter “laboratory utilization” in column 602. The sponsor may enter “inadequate process or controls within a selected laboratory” in column 604. The sponsor may enter “3” in column 606. In column 608, the sponsor may enter:
Inability to leverage testing done by lab.
   In column 610, the sponsor may enter:
1) Missing current laboratory license, certification or accreditation (Sev-3).
2) Missing laboratory director credentials (Sev-3).
3) Inadequate or missing laboratory reference ranges (Sev-3).
4) Inadequate or missing documentation/updates when laboratory equipment is changed.
   In column 618, the sponsor may enter:
1) Review and collect information obtained during lab qualification or audits.
2) Determine if risk exists in utilizing lab.

Furthermore, in a 12^{th} a row of table 600, the sponsor may enter “source document process” in column 602. The sponsor may enter “inadequate source data (e.g. missing, not complete” in column 604. The sponsor may enter “4” in column 606. In column 608, the sponsor may enter:
Lost enrollment.
Site separation.
Risk to study outcomes.
   In column 610, the sponsor may enter:
1) Inadequate, missing and/or questionable source records (Sev-4).
2) Inadequate or missing source document template (Sev-3).
   In column 612, the sponsor may enter:
1) Monitoring visit.
   In column 614, the sponsor may enter:
1) Monitoring action items (Section 1—Monitoring Action Item Code List).
   In column 616, the sponsor may enter.
1) When electronic medical date records are accessible with technology, some of the issues with source data verification will go away.
   In column 618, the sponsor may enter:
1) Trend existing monitoring actions (study/site).
2) Assess frequency of occurrence at site.
   In column 620, the sponsor may enter:
1) If multiple occurrences, same actions and multiple patients—determine future risk at site and plan monitoring trips accordingly.

Furthermore, in a 13^{th} row of table 600, the sponsor may enter “vendor utilization” in column 602. The sponsor may enter “Leveraging a vendor with potential for regulatory audit findings (e.g. no vendor controls, no vendor qualification, never audited)” in column 604. The sponsor may enter “4” in column 606. In column 608, the sponsor may enter:
Non-compliant vendor (separation from study).
Data/software from vendor cannot be utilized by study team.
Rework.
Increased financial burden.
   In column 610, the sponsor may enter:
1) Missing audit verifications.
2) Vendor qualification not performed.
3) No confirmation and reliability of data.
   In column 612, the sponsor may enter:
1) Schedule audit.
   In column 614, the sponsor may enter:
1) Monitoring action.
2) Quality revision.
   In column 616, the sponsor may enter:
1) Automate within electronic data collection system (manage at sign-on time) a delegated task list review, on some regular basis (e.g. enrollments, monthly) for the site to verify correct and matches current site personnel, generate query if changes have occurred.
2) Trend site.

FIG. 13 is a conceptual diagram that illustrates a second example table 700 for risk designation. The sponsor may enter information into table 700 when categorizing failure modes prior to the start of a trial. Each row in table 700 may correspond to a different failure mode category. Table 700 includes a study column 702, a risk category column 704, an observation column 706, a severity column 708, an occurrence of severity column 710, a mitigation actions column 712, criteria to consider column 714, a future manual/automate column 716, and a timing of automation column 718. The sponsor may enter core value opportunity indicators for failure modes in column 702. The sponsor may enter risk categories for failure modes in column 704. The sponsor may enter observations of failure modes in column 706. The sponsor may enter severity scores for failure modes in column 708. The sponsor may enter occur to severity indicators in column 710. The sponsor may enter mitigation actions in column 712. The sponsor may enter criteria to consider for failure modes in column 714. The sponsor may enter indications of whether to perform manual or automated responses to failure modes in column 716. The sponsor may enter information about the timing of automation in column 718.

For example, in a first row of table 700, the sponsor may enter “high” in column 702, “critical study element risk” in column 704, “failure to comply with protocol” in column 706, and “4” in column 708. The sponsor may leave the other columns of the first row blank.

In a second row of table 700, the sponsor may enter “high” in column 702, “critical study element risk” in column 704, “randomization errors” in column 706, and “4” in column 708. The sponsor may leave the other columns of the second row blank.

In a third row of table 700, the sponsor may enter “high” in column 702, “critical study element risk” in column 704, “protocol inconsistencies” in column 706, and “4” in column 708. The sponsor may leave the other columns of the third row blank.

In a fourth row of table 700, the sponsor may enter “high” in column 702, “critical study element risk” in column 704, “protocol non-compliance (e.g., patient visits, randomization issues, blinding issues)” in column 706, and “4” in column 708. The sponsor may leave the other columns of the fourth row blank.

In a fifth row of table 700, the sponsor may enter “medium” in column 702, “critical study element risk” in column 704, “complexity of protocol” in column 706, and “3” in column 708. The sponsor may leave the other columns of the fifth row blank.

In a sixth row of table 700, the sponsor may enter “very high” in column 702, “critical study element risk” in column 704, “failure to follow investigational plan” in column 706, and “5” in column 708. The sponsor may leave the other columns of the sixth row blank.

In a seventh row of table 700, the sponsor may enter “high” in column 702, “data management” in column 704, “delayed query resolution” in column 706, and “4” in column 708, “set boundaries for concerns (i.e., 30 days)” in column 710, “redefine, communicate and set expectations (timely resolutions) in column 712, “define/implement roles and responsibilities within sponsor” in column 714, and “automate” in column 716. The sponsor may leave column 718 of the seventh row blank.

In an eighth row of table 700, the sponsor may enter “low” in column 702, “data management” in column 704, “data collection issues (e.g., entry of CRF)” in column 706, and “1” in column 708. The sponsor may leave the other columns of the eighth row blank.

In a ninth row of table 700, the sponsor may enter “high” in column 702, “documentation” in column 704, “delegation task list (inadequate/missing) at site—should contain initials and signatures (verify consistent practice)” in column 706, “5” in column 708, and “delegated task list and training” in column 714. The sponsor may leave the other columns of the ninth row blank.

In a tenth row of table 700, the sponsor may enter “low” in column 702, “documentation” in column 704, “missing signed agreements (e.g., investigator, financial disclosure, trial agreements, form FDA 1572)” in column 706, and “1 or 2” in column 708, and “verify process at sponsor to understand risk in this area, in particular new acquisitions” in column 712. The sponsor may leave the other columns of the tenth row blank.

In an eleventh row of table 700, the sponsor may enter “low” in column 702, “documentation” in column 704, “missing or inconsistent signatures/handwriting (e.g., site signature log” in column 706, and “2” in column 708. The sponsor may leave the other columns of the eleventh row blank.

In a twelfth row of table 700, the sponsor may enter “low” in column 702, “documentation” in column 704, “discrepancy between sponsor/CRO/site records” in column 706, “1” in column 708, and “reconciliation process” in column 712. The sponsor may leave the other columns of the twelfth row blank.

In a thirteenth row of table 700, the sponsor may enter “low” in column 702, “documentation” in column 704, “missing protocol, amendments or administrative documents” in column 706, “3” in column 708, and “do they have deviations?” in column 714. The sponsor may leave the other columns of the thirteenth row blank.

In a fourteenth row of table 700, the sponsor may enter “low” in column 702, “documentation” in column 704, “missing updated CV's of study personnel” in column 706, and “2” in column 708. The sponsor may leave the other columns of the fourteenth row blank.

In a fifteenth row of table 700, the sponsor may enter “low” in column 702, “documentation” in column 704, “inadequate or missing delegation of authority documents (sponsor) delegation of services provided (Core lab, CRO, etc.)” in column 706, and “4” in column 708. The sponsor may leave the other columns of the fifteenth row blank.

In a sixteenth row of table 700, the sponsor may enter “low” in column 702, “documentation” in column 704, “inadequate or missing documentation for site personnel training” in column 706, and “3” in column 708 in column 714. The sponsor may leave the other columns of the sixteenth row blank.

In a seventeenth row of table 700, the sponsor may enter “low” in column 702, “documentation” in column 704, “maintaining site regulatory binder filings” in column 706, and “1” in column 708. The sponsor may leave the other columns of the seventeenth row blank.

In an eighteenth row of table 700, the sponsor may enter “medium” in column 702, “documentation” in column 704, “identification of problem with record keeping (e.g., site organizational management of documentation” in column 706, “3” in column 708, “capturing monitoring reports—how organized is the sit” in column 714, and “automate” in column 716. The sponsor may leave the other columns of the eighteenth row blank.

In a nineteenth row of table 700, the sponsor may enter “medium” in column 702, “documentation” in column 704, “inadequate or missing subject identification log” in column 706, “3” in column 708, and “do they have deviations?” in column 714. The sponsor may leave the other columns of the nineteenth row blank.

In a 20^{th} row of table 700, the sponsor may enter “very high” in column 702, “documentation” in column 704, “inadequate or missing documentation of protocol exemptions, deviations and/or violation” in column 706, and “5” in column 708. The sponsor may leave the other columns of the 20^{th} row blank.

In a 21^{st} row of table 700, the sponsor may enter “high” in column 702, “facility risk” in column 704, “inadequate device accountability” in column 706, and “4” in column 708. The sponsor may leave the other columns of the 21^{st} row blank.

In a 22^{nd} row of table 700, the sponsor may enter “low” in column 702, “facility risk” in column 704, “existence of written site SOP's/GCP compliance” in column 706, and “1” in column 708. The sponsor may leave the other columns of the 22^{nd} row blank.

In a 23^{rd} row of table 700, the sponsor may enter “low” in column 702, “facility risk” in column 704, “inadequate or missing facilities protocol procedures” in column 706, and “4” in column 708. The sponsor may leave the other columns of the 23^{rd} row blank.

In a 24^{th} row of table 700, the sponsor may enter “verify process” in column 702, “facility risk” in column 704, “unsecured investigational product storage area space” in column 706, and “4” in column 708. The sponsor may leave the other columns of the 24^{th} row blank.

In a 25^{th} row of table 700, the sponsor may enter “high” in column 702, “IRB” in column 704, “failure to obtain IRB/IEC approvals” in column 706, and “5” in column 708. The sponsor may leave the other columns of the 25^{th} row blank.

In a 26^{th} row of table 700, the sponsor may enter “high” in column 702, “IRB” in column 704, “missing IRB/IEC approval subject consent/asset form” in column 706, and “4” in column 708. The sponsor may leave the other columns of the 26^{th} row blank.

In a 27^{th} row of table 700, the sponsor may enter “high” in column 702, “IRB” in column 704, “failure to follow conditions of approval imposed by IRB/IEC” in column 706, and “4” in column 708. The sponsor may leave the other columns of the 27^{th} row blank.

In a 28^{th} row of table 700, the sponsor may enter “low” in column 702, “IRB” in column 704, “failure to submit progress/annual/final reports to IRB/IEC” in column 706. “3” in column 708, and “trial master file—we should be looking for at time of closure” in column 714. The sponsor may leave the other columns of the 28^{th} row blank.

In a 29^{th} row of table 700, the sponsor may enter “low” in column 702, “IRB” in column 704, “inadequate or missing IRB/IEC communication and submission documents” in column 706, and “2” in column 708. The sponsor may leave the other columns of the 29^{th} row blank.

In a 30^{th} row of table 700, the sponsor may enter “low” in column 702. “IRB” in column 704, “missing IRB/IEC member roster” in column 706, and “2” in column 708: The sponsor may leave the other columns of the 30^{th} row blank.

In a 31^{st} row of table 700, the sponsor may enter “very high” in column 702, “IRB” in column 704, “IRB suspension” in column 706, and “5” in column 708. The sponsor may leave the other columns of the 31^{st} row blank.

In a 32^{nd} row of table 700, the sponsor may enter “low” in column 702, “Lab” in column 704, “missing current laboratory license, certification or accreditation” in column 706, and “3” in column 708. The sponsor may leave the other columns of the 32^{nd} row blank.

In a 33^{rd} row of table 700, the sponsor may enter “low” in column 702, “Lab” in column 704, “missing laboratory director credentials” in column 706, and “3” in column 708. The sponsor may leave the other columns of the 33^{rd} row blank.

In a 34^{th} row of table 700, the sponsor may enter “medium” in column 702, “Lab” in column 704, “inadequate or missing laboratory reference ranges” in column 706, and “3” in column 708. The sponsor may leave the other columns of the 34^{th} row blank.

In a 35^{th} row of table 700, the sponsor may enter “medium” in column 702, “Lab” in column 704, “inadequate or missing documentation/updates when laboratory equipment is changed” in column 706, and “3” in column 708. The sponsor may leave the other columns of the 35^{th} row blank.

In a 36^{th} row of table 700, the sponsor may enter “high” in column 702, “patient consent” in column 704, “inadequate subject consent/assent form” in column 706, and “4” in column 708. The sponsor may leave the other columns of the 36^{th} row blank.

In a 37^{th} row of table 700, the sponsor may enter “high” in column 702, “patient consent” in column 704, “inadequate consenting process” in column 706, and “4” in column 708. The sponsor may leave the other columns of the 37^{th} row blank.

In a 38^{th} row of table 700, the sponsor may enter “high” in column 702, “patient consent” in column 704, “missing or illegible signatures, dates, and/or times on subject consent form” in column 706, and “4” in column 708. The sponsor may leave the other columns of the 38^{th} row blank.

In a 39^{th} row of table 700, the sponsor may enter “high” in column 702, “patient consent” in column 704, “inadequate or missing documentation of re-consenting process” in column 706, and “4” in column 708. The sponsor may leave the other columns of the 39^{th} row blank.

In a 40^{th} row of table 700, the sponsor may enter “high” in column 702, “patient consent” in column 704, “subject/patient confidentiality compromised” in column 706, and “4” in column 708. The sponsor may leave the other columns of the 40^{th} row blank.

In a 41^{st} row of table 700, the sponsor may enter “very high” in column 702, “patient consent” in column 704, “informed consent issues (e.g. timing, signature, missing)” in column 706, and “5” in column 708. The sponsor may leave the other columns of the 41^{st} row blank.

In a 42^{nd} row of table 700, the sponsor may enter “high” in column 702, “patient safety” in column 704, “safety issues (under reporting, timeliness)” in column 706, “4 or 5” in column 708, “depend on frequency and severity” in column 710, “confirm what study teams are doing to manage within reporting timelines” in column 712, “is there one episode at a site? Are there multiple episodes at a site?” in column 714, and “automate (trending across sites, occurrence) in column 716. The sponsor may leave the other columns of the 42^{nd} row blank.

In a 43^{rd} row of table 700, the sponsor may enter “patient safety” in column 702, “patient consent” in column 704, “safety data management (e.g., reporting safety issues)” in column 706, and “4” in column 708. The sponsor may leave the other columns of the 43^{rd} row blank.

In a 44^{th} a row of table 700, the sponsor may enter “high” in column 702, “site personnel” in column 704, “failure to follow written sponsor SOPs” in column 706, and “4” in column 708. The sponsor may leave the other columns of the 44^{th} row blank.

In a 45^{th} row of table 700, the sponsor may enter “high” in column 702, “site personnel” in column 704, “failure to maintain case histories” in column 706, and “4” in column 708. The sponsor may leave the other columns of the 45^{th} row blank.

In a 46^{th} row of table 700, the sponsor may enter “low” in column 702, “site personnel” in column 704, “personnel turnover at site” in column 706, “4” in column 708, “depends on frequency and how many and which resource” in column 710, “who left, what was their role, what is the phase or the study, several key people leave at same time, once we are notified look at impact” in column 714, and “automate” in column 716. The sponsor may leave the other columns of the 46^{th} row blank.

In a 47^{th} row of table 700, the sponsor may enter “low” in column 702, “site personnel” in column 704, “experience of investigator and study staff” in column 706, and “2” in column 708. The sponsor may leave the other columns of the 47^{th} row blank.

In a 48^{th} row of table 700, the sponsor may enter “low” in column 702, “site personnel” in column 704, “failure of investigator to meet with site monitor” in column 706, and “2” in column 708. The sponsor may leave the other columns of the 48^{th} row blank.

In a 49^{th} row of table 700, the sponsor may enter “low” in column 702, “site personnel” in column 704, “inappropriate delegation of authority” in column 706, and “3” in column 708. The sponsor may leave the other columns of the 49^{th} row blank.

In a 50^{th} row of table 700, the sponsor may enter “low” in column 702, “site personnel” in column 704, “lack of site responsiveness (e.g., follow-up with monitors, study teams)” in column 706, and “2” in column 708. The sponsor may leave the other columns of the 50^{th} row blank.

In a 51^{st} row of table 700, the sponsor may enter “medium” in column 702, “site personnel” in column 704, “missing or inadequate credentials of research staff (specific to testing done—who is required” in column 706, and “4” in column 708. The sponsor may leave the other columns of the 51^{st} row blank.

In a 52^{nd} row of table 700, the sponsor may enter “medium” in column 702, “site personnel” in column 704, “inadequate investigator involvement/oversight” in column 706, and “3” in column 708. The sponsor may leave the other columns of the 52^{nd} row blank.

In a 53^{rd} row of table 700, the sponsor may enter “high” in column 702, “source data” in column 704, “inadequate, missing and/or questionable source record” in column 706, and “4” in column 708. The sponsor may leave the other columns of the 53^{rd} row blank.

In a 54^{th} row of table 700, the sponsor may enter “medium” in column 702, “source data” in column 704, “inadequate or missing source document template” in column 706, and “3” in column 708. The sponsor may leave the other columns of the 54^{th} row blank.

In a 55^{th} row of table 700, the sponsor may enter “high” in column 702, “study execution” in column 704, “repetitive protocol non-compliance” in column 706, “4” in column 708, “seen through various process/date lenses” in column 710, “training (increased, targeted) SIV more time spent, early and frequency IMV (depending on issues)” in column 712, “is this a repeated issue at this site? If high risk, should we suspend enrollment?” in column 714, and “automate” in column 716. The sponsor may leave the other columns of the 55^{th} row blank.

In a 56^{th} row of table 700, the sponsor may enter “low” in column 702, “study execution” in column 704, “lack of site prior performance history” in column 706, “3” in column 708, “SIV with targeted training, early IMV” in column 712, “first time site participates in sponsor study, review previous baseline information on performance, new therapeutic area, baseline expectations of performance, staff level changes at site (e.g. coordinator, new Investigator)” in column 714, and “automate” in column 716. The sponsor may leave the other columns of the 56^{th} row blank.

In a 57^{th} row of table 700, the sponsor may enter “low” in column 702, “study execution” in column 704, “prior history of FDA 483” in column 706, “2” in column 708, “what was in the 483” in column 710, “based on content of 483” in column 712, and “automate” in column 716. The sponsor may leave the other columns of the 57^{th} row blank.

In a 58^{th} row of table 700, the sponsor may enter “low” in column 702, “study execution” in column 704, “rate of recruitment/enrollment” in column 706, and “3” in column 708, “based on enrollment vs. sponsor expectations” in column 710, “provide reporting to proactively understand the % differences, determine response based on analysis” in column 712, “what is our enrollment expectation, what %+/− differences would we watch, what is the quality of the data” in column 714, and “automate” in column 716. The sponsor may leave the other columns of the 58^{th} row blank.

In a 59^{th} row of table 700, the sponsor may enter “low” in column 702, “study execution” in column 704, “inadequate or missing patient compensation” in column 706, and “3” in column 708. The sponsor may leave the other columns of the 59^{th} row blank.

In a 60^{th} row of table 700, the sponsor may enter “medium” in column 702, “study execution” in column 704, “high relative to other sites (deviation reporting)” in column 706, and “3” in column 708. The sponsor may leave the other columns of the 60^{th} row blank.

In a 61^{st} row of table 700, the sponsor may enter “study execution” in column 704, “pre-defined study specific metric variances” in column 706, “3” in column 708, “depends on the variables we are considering” in column 710, “data management plan and data quality plan, study project plans, monitoring metrics/site, etc.” in column 712, “how do we handle financial variances” in column 714, and “automate” in column 716. The sponsor may leave the other columns of the 61^{st} row blank.

In a 62^{nd} row of table 700, the sponsor may enter “study execution” in column 704, “information from biostatistician on inaccuracies or repetitive data read” in column 706, “establish a trending (Future)” in column 712, “Is there a difference in Stats plan and how analysis was done? Did the stats method change from plan or begin with closure of current studies? Retrospective analysis of SAP & final analysis” in column 714, and “manual” in column 716. The sponsor may leave the other columns of the 62^{nd} row blank or determine values for the other columns.

In a 63^{rd} row of table 700, the sponsor may enter “high” in column 702, “trial related risk” in column 704, “inadequate or inappropriate subject identification” in column 706, and “4” in column 708. The sponsor may leave the other columns of the 63^{rd} row blank or determine values for the other columns.

In a 64^{th} row of table 700, the sponsor may enter “medium” in column 702, “trial related risk” in column 704, “inadequate or missing subject screening and enrollment log” in column 706, and “3” in column 708. The sponsor may leave the other columns of the 64^{th} row blank or determine values for the other columns.

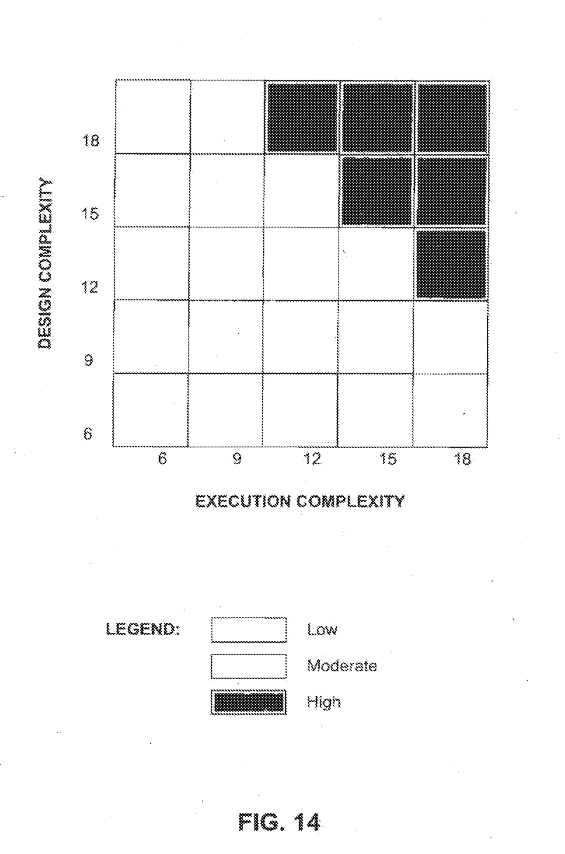

FIG. 14 is a conceptual diagram that illustrates an example risk model. In the example of FIG. 14, low risk is generally associated with relatively low design complexity and relatively low execution complexity. In contrast, high risk is generally associated with relatively high design complexity and relatively high execution complexity. Various types of risks may be assessed. These types of risks may include site-level risk, study-level design risk, and sponsor-level risk.

Site-level risks may include geographic location, investigator and staff experience, current study load at the site, sponsor/investigator relationship, quantity of data. GCP compliance and availability of electronic data capture (EDC) and electronic medical record (EMR). Example factors associated with site-level risk may include the number of geographies (and their maturity), the investigators at the site (including prior history of FDA Form 483/warning letters, whether the investigator at the site is new, etc.), the sponsor/investigator relationship (e.g., whether the site has prior research history with the sponsor), the technology used at the site (e.g., electronic data capture, electronic medical records, etc.), the quantity of data, good clinical practice (GCP) compliance history, and so on.

Study-level risks may include study endpoints, procedures, product risk/benefit profile, and the length of study, as well as the disease state and study population morbidities. Example factors associated with study-level design risk may include study type and/or regulatory designation, study endpoints, sub-study components, number of procedures, enrollment, number of centers, a product safety profile, a risk/benefit analysis, a study duration, the complexity of the study population and/or protocol, and so on.

Sponsor-level risks may include risk of external audit, type of regulatory filing, first-in-man or new technology, and impact on business. Example factors associated with sponsor-level risk include whether the study relates to a new technology (e.g., first-in-man, lack of product performance history, risk of regulatory audit, feasibility or concept validation study, etc.), a stakeholder value of investigational product (e.g., high media visibility or public relations interest), regulatory challenges, and so on.

A sponsor core team may conduct an in-depth review including risk identification, analysis and designation (high, medium or low risk), addressing patient safety factors and comparing potential risk of study intervention against standard medical care for the indication. The core team identifies known or anticipated risks based on the investigational product's risk/benefit profile, study procedures for the condition under investigation, and indicators of potential site-related risks (personnel turnover, workload, site performance, rate of enrollment and data quality).

Historically, tasks that could only be performed on-site may now be done remotely with wide sponsor adoption of electronic data capture (EDC), mobile technologies, webcasts, e-mail and CTMS systems, assuring monitors have more immediate access to data points and options when planning and conducting visits. The combination of targeted on-site, remote and/or triggered monitoring while reducing overall monitoring costs, may allow monitors to use risk indicators (high, medium or low) to drive the level of monitoring intensity. Failure to obtain informed consent may be an example of a high-risk indicator that requires 100% monitoring. The monitoring strategy may focus on those trial data and information that are critical for assessment of subject safety and protection, confirmation of regulatory and protocol compliance, with focus on key data supporting primary trial objectives.

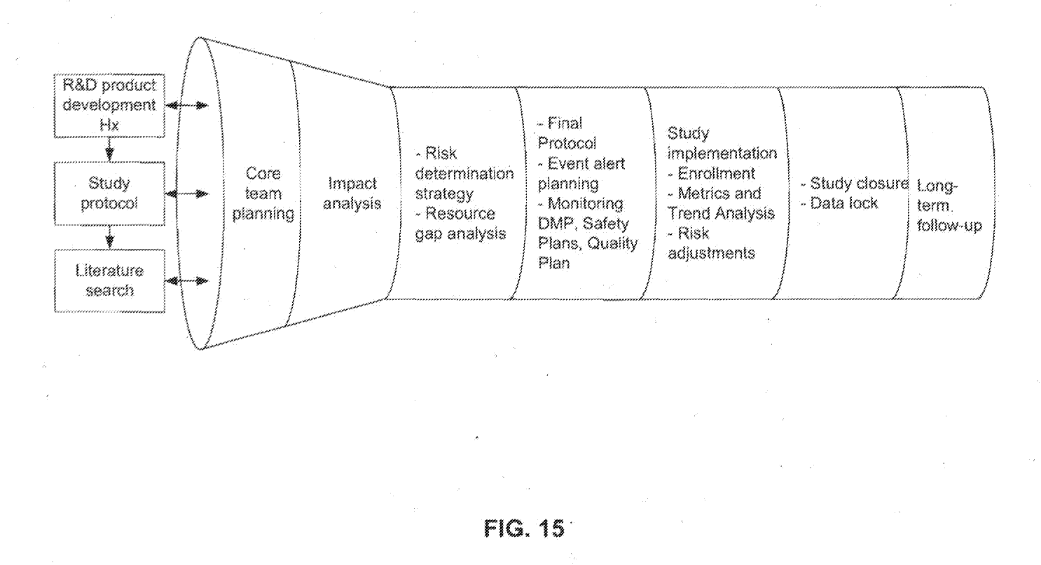

FIG. 15 is a conceptual diagram that illustrates an example quality risk planning and management process. The example process of FIG. 15 may be a model for driving optimal trial performance. The concept of risk evaluation and mitigation as a foundation for setting monitoring intensity may begin with a core team review of the study protocol, literature search and analysis of risks associated with the investigational product, study population, trial procedures and impact of risks on business objectives. The process may begin early in the trial-planning phase with representatives of the study team, safety, monitoring, biometrician, and data management addressing site, study and business risks.

The example process of FIG. 15 may include assembly of a core team, a risk assessment and control process; and risk analysis and adjustment across the life of the trial. While the framework may vary from case to case commensurate with specific risks associated with the investigational product, the study population and complexity of the protocol, the risk analysis document is created before the trial begins and is used to justify the trial. As new risks are identified, adjustments may be made throughout the trial.

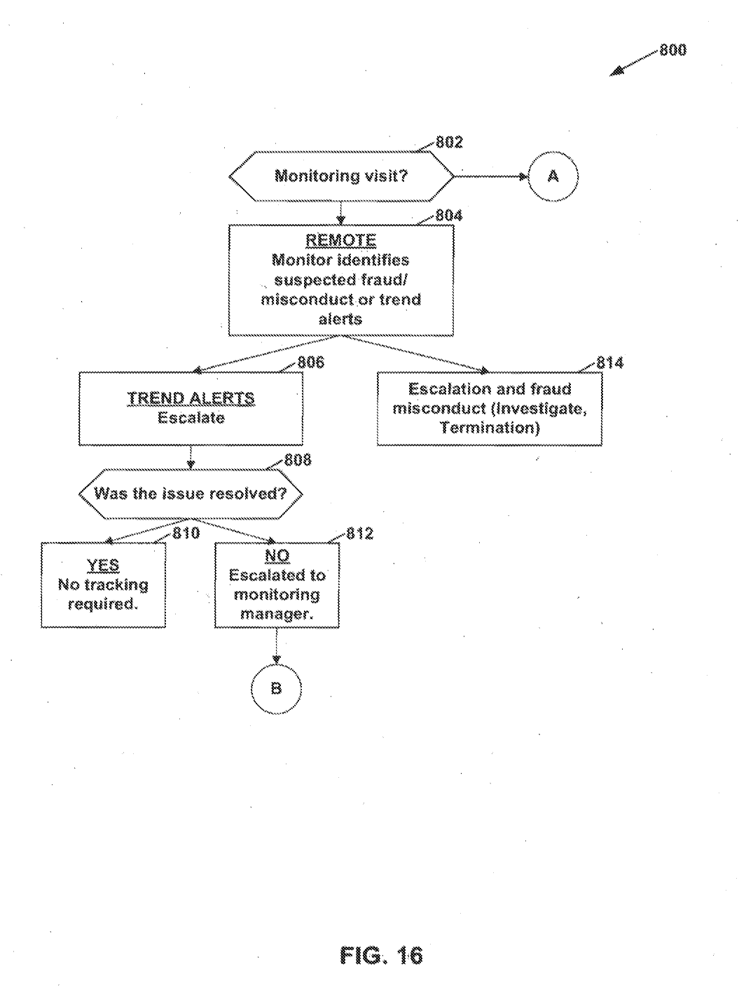

FIG. 16 is a flowchart illustrating a first portion of an example monitoring plan 800. When preparing a monitoring plan, it may be important to define the activities that will be performed by remote monitors and those completed by field-based monitors. Remote monitoring may include review of regulatory documentation including CVs, licenses, financial disclosure forms, review of IRB correspondence, clinical supply and IP product shipments, site communication, monitoring reports and action items, confirmation of site personnel training and study logs. Utilizing a single, centralized metrics dashboard may enable quick identification and assessment of emerging site issues. Field-based monitoring focus may include site and IRB SOP requirements, informed consent documentation, SDV, adverse event documentation and reporting within required timeframe, subject confirmation of eligibility, investigational product accountability, focus on study endpoints, regulatory and protocol compliance, as well as site performance issues. The monitoring plan may be broad enough to include built-in flexibility, triggers that would require review, revision and a study risk escalation plan.

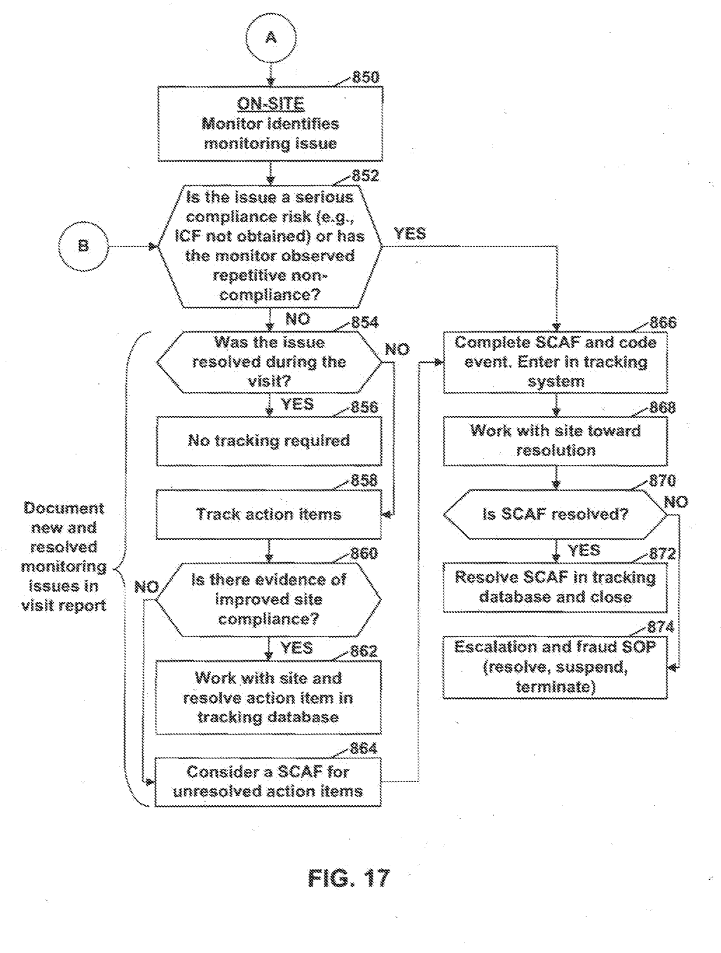

As indicated by box 802 in FIG. 16, monitoring plan 800 has two branches, one for remote monitoring and one for on-site monitoring. The branch for remote monitoring is shown in FIG. 16. The branch for on-site monitoring (represented in FIG. 16 as “A”) is shown in FIG. 17. As indicated by box 804, a remote monitor may identify suspected fraud and/or misconduct and trend alerts. In box 806, the remote monitor may determine, based on a trend alert, whether to escalate an issue. Subsequently, in box 808, the remote monitor may determine whether the issue was resolved. If the issue was resolved, no tracking may be required (box 810). Otherwise, if the issue was not resolved, the remote monitor may escalate the issue to a monitoring manager (box 812) and a portion starting with “B” in FIG. 17 may be performed. Furthermore, as indicated by box 814, if the remote monitor identifies suspected fraud and/or misconduct, the remote monitor may escalate the issue which may lead to termination of the site and/or study.

FIG. 17 is a flowchart illustrating a second portion of the example monitoring plan 800 of FIG. 16. As indicated by box 850 in FIG. 17, an on-site monitor may identify a monitoring issue. In addition, the on-site monitor may determine whether the issue is a serious compliance risk (e.g., whether an ICF has not been obtained) or whether the on-site monitor has observed repetitive non-compliance. If the issue is not a serious compliance risk or the on-site monitor has not observed repetitive non-compliance, the on-site monitor may determine whether the issue was resolved during the on-site visit (box 854). As indicated by box 856, if the issue was resolved during the on-site visit, no tracking may be required. However, if the issue was not resolved during the on-site visit, tracking of items may be required (box 854). For instance, an action item may be opened in a tracking database. Subsequently, the on-site monitor (or other entity) may determine whether is there is evidence of improved site compliance (box 860). If there is evidence of improved site compliance, the on-site monitor (or other entity) may work with the site and resolve the action item in the tracking database (box 862). Otherwise, if there is no evidence of improved site compliance, the on-site monitor (or other entity) may consider a site compliance alert form (SCAF) for unresolved action items in the tracking database (box 864).

If the issue identified by the on-site monitor is a serious compliance risk or the on-site monitor has observed repetitive non-compliance, or after considering a SCAF for unresolved action items, the on-site monitor (or other entity) may complete a SCAF, code the event, and enter the event in a tracking system (e.g., a tracking database) (box 866). Furthermore, the on-site monitor (or other entity) may work with the site toward resolution of the issue (box 868). Subsequently, the on-site monitor (or other entity) may determine whether the SCAF is resolved (box 870). If the SCAF is resolved, the on-site monitor (or other entity) may resolve the SCAF in the tracking database and close the issue (box 872). Otherwise, if the SCAF is not resolved, the on-site monitor (or other entity) may escalate the issue and perform fraud standard-operating-procedures (e.g., resolve, suspend, or terminate the trial) (box 874).

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various examples have been described. These and other examples are within the scope of the following claims.

What is claimed is:

1. A method comprising:
receiving, at a computer system, before a start of a trial of a medical therapy, data that configure the computer system to detect alert conditions indicative of occurrences of failure modes identified as being potentially associated with the trial;
receiving, at the computer system, trial data generated during conduct of the trial;
detecting, by the computer system based on the trial data, that one of the alert conditions has occurred, the alert condition indicative of an occurrence of a given one of the failure modes; and
outputting, by the computer system in response to detecting that the alert condition has occurred, an alert associated with a mitigation procedure defined for the given failure mode before the start of the trial, the mitigation procedure indicating a procedure to mitigate the occurrence of the given failure mode.

2. The method of claim 1, wherein the mitigation procedure indicates that a mitigation team is to intervene in the trial to mitigate the given failure mode.

3. The method of claim 1, wherein outputting the alert comprises outputting the alert to a monitoring organization that monitors the conduct of the trial.

4. The method of claim 3, further comprising indicating, by the computer system, that the mitigation procedure requires a site visit to be conducted.

5. The method of claim 1,
wherein the given failure mode involves a data consistency issue; and
wherein the alert includes a prompt to resolve the data consistency issue.

6. The method of claim 1, wherein receiving the data that configure the computer system to detect the alert conditions comprises receiving software instructions that configure the computer system to detect the alert conditions.

7. The method of claim 1, wherein receiving the data that configure the computer system to detect the alert conditions comprises receiving user input to configure the computer system to detect the alert conditions.

8. The method of claim 1,
wherein the method further comprises:
storing, by the computer system, priority scores associated with the failure modes, wherein the priority scores are determined prior to the start of the trial; and
outputting, by the computer system, an indication of the priority score associated with the given failure mode; and
wherein mitigation procedures defined for ones of the failure modes associated with higher priority scores involve greater monitoring intensity than mitigation procedures defined for ones of the failure modes associated with relatively lower priority scores.

9. The method of claim 8,
wherein each of the failure modes is associated with a priority score that is determined prior to the start of the trial;
wherein failure modes associated with a first priority score are determined before the start of the trial to likely have limited impact on the trial, involve no safety issues, have no impact on operation of the trial, and have minimal financial impact;
wherein failure modes associated with a second priority score are determined before the start of the trial to likely have some impact on the trial which can be mitigated and to likely have minimal financial impact;
wherein failure modes associated with a third priority score are determined before the start of the trial to likely impact the trial in a way that can be mitigated and likely to have financial, operational, or regulatory impacts that cannot be mitigated except through intervention;
wherein failure modes associated with a fourth priority score are determined before the start of the trial to likely impact trial conduct or subject safety and require on-site visits, investigation site audits, investigation site retraining, site closure, or escalation of monitoring activities; and
wherein failure modes associated with a fifth priority score are determined before the start of the trial to likely disrupt trial conduct or subject safety in a way that requires immediate escalation.

10. The method of claim 9,
wherein the method further comprises outputting, by the computer system, an indication of the mitigation procedure associated with the alert;
wherein if the given failure mode has the first priority score, the mitigation procedure associated with the alert involves a routine site visit;
wherein if the given failure mode has the second priority score, the mitigation procedure associated with the alert involves routine monitoring to determine an extent and impact of the occurrence of the given failure mode;
wherein if the given failure mode has the third priority score, the mitigation procedure associated with the alert involves a determination of the extent and impact of the occurrence of the given failure mode and a determination of whether escalation to a sponsor of the trial is required;
wherein if the given failure mode has the fourth priority score, the mitigation procedure associated with the alert involves securing additional information about the occurrence of the failure mode, conducting a monitoring visit, and determining whether escalation to the sponsor of the trial is necessary; and
wherein if the given failure mode has the fifth priority score, the mitigation procedure associated with the alert involves immediate intervention.

11. The method of claim 1, wherein receiving the trial data comprises receiving, at the computer system, electronic case report forms (CRFs) that contain the trial data.

12. The method of claim 1,
wherein the trial data originates from multiple investigation sites; and
wherein detecting that one of the alert conditions has occurred comprises determining, by the computer system, whether the trial data originating from one of the investigation sites is inconsistent with the trial data originating from other ones of the investigation sites.

13. The method of claim 1, further comprising receiving, by the computer system after the start of the trial, additional data that reconfigure the computer system to detect additional alert conditions, the additional alert conditions indicative of occurrences of the failure modes or additional failure modes identified as being potentially associated with the trial.

14. The method of claim 13, further comprising receiving the additional data on a periodic basis during the trial.

15. The method of claim 1, wherein the alert indicates the mitigation procedure associated with the alert.

16. A computer system that comprises one or more processing units that are configured to:
receive, before a start of a trial of a medical therapy, data that configure the computer system to detect alert conditions indicative of occurrences of failure modes identified as being potentially associated with the trial;
receive trial data generated during conduct of the trial;
detect, based on the trial data, that one of the alert conditions has occurred, the alert condition indicative of an occurrence of a given one of the failure modes; and
output, in response to detecting that the alert condition has occurred, an alert associated with a mitigation procedure defined for the given failure mode before the start of the trial, the mitigation procedure indicating a procedure to mitigate the occurrence of the given failure mode.

17. The computer system of claim 16, wherein the one or more processing units are configured to output the alert to a monitoring organization that monitors the conduct of the trial.

18. The computer system of claim 16,
wherein the given failure mode involves a data consistency issue;
wherein the mitigation is plan defined for the given failure mode; and
wherein the one or more processing units are configured to output the alert, the alert including a query that prompts to resolve the data consistency issue.

19. The computer system of claim 16,
wherein each of the failure modes is associated with a priority score that is determined prior to the start of the trial; and
wherein mitigation procedures defined for ones of the failure modes associated with higher priority scores involve greater monitoring intensity than mitigation procedures defined for ones of the failure modes associated with relatively lower priority scores.

20. The computer system of claim 16,
wherein the trial data originates from multiple investigation sites; and
wherein the one or more processing units are configured to detect that one of the alert conditions has occurred when the one or more processing units determine that the trial data originating from one of the investigation sites is inconsistent with the trial data originating from other ones of the investigation sites.

21. A computer-readable storage medium that stores computer-executable instructions that, when executed, configure a computer system to:
receive, before a start of a trial of a medical therapy, data that configure the computer system to detect alert conditions indicative of occurrences of failure modes identified as being potentially associated with the trial;
receive trial data generated during conduct of the trial;
detect, based on the trial data, that one of the alert conditions has occurred, the alert condition indicative of an occurrence of a given one of the failure modes; and
output, in response to detecting that the alert condition has occurred, an alert associated with a mitigation procedure defined for the given failure mode before the start of the trial, the mitigation procedure indicating a procedure to mitigate the occurrence of the given failure mode.
